(19) United States
(12) Patent Application Publication
(10) Pub. No.: US 2025/0225041 A1
(43) Pub. Date: Jul. 10, 2025

(54) COMPUTER IMPLEMENTED SYSTEMS AND METHODS FOR ELECTRONIC DATA MANAGEMENT

(71) Applicant: Advanced Data Risk Management, LLC, Woburn, MA (US)

(72) Inventors: Daniel O'Neill, Arlington, MA (US); Matthew Isgur, Haverhill, MA (US)

(73) Assignee: Advanced Data Risk Management, LLC, Woburn, MA (US)

(21) Appl. No.: 18/943,422

(22) Filed: Nov. 11, 2024

Related U.S. Application Data
(60) Provisional application No. 63/618,127, filed on Jan. 5, 2024.

(51) Int. Cl. G06F 11/30

(52) U.S. Cl. CPC G06F 11/3068; G06F 11/3006

(57) ABSTRACT

In accordance with at least one aspect of this disclosure, there is provided, an artificial intelligence/machine learning (AI/ML) data aggregation module configured to aggregate and parse electronic data from a plurality of systems (e.g., which system(s) may be based on a site location/building) each including a plurality of assets/devices, for determining one or more analytics (e.g., trends) for the assets/devices. In certain embodiments, the AI/ML aggregation module can be configured to receive system data directly and in real time from each of the plurality of systems through one or more communication channels and media formats.

### CROSS-REFERENCE TO RELATED APPLICATIONS

This application claims priority to and the benefit of U.S. Provisional Patent Application No. 63/618,127 filed Jan. 5, 2024.

### TECHNICAL FIELD

The present disclosure relates to computer implemented systems and methods for data management, and more particularly to computer implemented systems and methods utilizing Machine Learning (ML) and/or Artificial Intelligence (AI) techniques for managing electronic data and/or a plurality of devices/assets.

### BACKGROUND

Facility management (e.g., management of security systems) of an enterprise's electronic data and/or geographically dispersed assets/devices is becoming increasingly complex for monitoring and providing services for multiple technologies, data sources, data types, devices, assets, and software/firmware, licenses, and other electronic information. Existing management systems currently lack a unified solution that comprehensively manages and analyzes numerous assets/devices, data types and formats associated with an enterprise for facilitating proactive and organized management and reporting.

The conventional techniques have been considered satisfactory for their intended purpose. However, there is an ever-present need for improved systems and methods for data management, including electronic data and asset management, such as, but not limited to, security systems. This disclosure provides a solution for this need.

### SUMMARY

In accordance with at least one aspect of this disclosure, a computer-implemented method for a monitoring device having a computer processor for determining one or more analytics for aggregated assets is provided. The monitoring device can include a plurality of modules configured to monitor and manage all aspects of system management under a single engine to ensure all assets associated with one or more entities are kept up to date, running, and performing as intended. In certain embodiments, the method includes capturing, by the computer processor, via a communications network, data from a plurality of assets associated with at least one entity. The captured data has a plurality of different data file formats.

The method further includes, storing the captured data, by the computer processor, in a storage device and normalizing the captured data stored in the storage device, by the computer processor, to have one or more standardized data formats.

The method further comprises analyzing, by the computer processor, the normalized captured data using one or more Artificial Intelligence (AI) techniques to aggregate the captured asset data into one or more assets data sets, where each aggregated asset data set is associated with a common asset functionality, and further includes, analyzing, by the computer processor, using one or more Artificial Intelligence AI techniques, each aggregated asset data set to determine one or more functionality trends associated with assets in each aggregated asset data set.

In certain embodiments, the one or more AI techniques apply one or more AI models to the normalized captured asset data for classifying the normalized captured asset data so as to be aggregated into the one or more assets data sets.

In certain embodiments, the one or more AI techniques apply one or more AI models to the one or more asset data sets for determining the one or more functionality trends associated with assets in each aggregated asset data set. In certain embodiments, generative AI techniques and/or models are utilized. In certain embodiments, an internal AI model is used and is trained on captured trends and historical data parsed from the aggregated data sets, for example.

In certain embodiments, the functionality trends include performance metrics according to prescribed criteria (e.g., suitable operating conditions, geographic location, installation location, among others).

In certain embodiments, the network use a LoRaWAN network.

In certain embodiments, the data format files include either binary or text-based files.

In certain embodiments, the plurality of assets include one or more of security devices (e.g., including security cameras, security door locks, security key card access panels, security biometric panels, security alarms, seismic detection systems, and/or fire detection systems), fire control or detection devices, key or key card control devices, video access devices, building access panel devices, and/or environment control systems.

In certain embodiments, the captured data include operational data associated with a specific asset. In certain embodiments, the captured operational data be captured in real-time.

In accordance with at least one aspect of this disclosure, a non-transitory computer readable medium having computer executable instructions configured to cause a computer to perform a method is provided. In certain embodiments, the method is a method for a monitoring device having a computer processor for determining one or more analytics for aggregated assets. In certain embodiments, the method is as described hereinabove.

In accordance with at least one aspect of this disclosure, a monitoring system is provided. In certain embodiments, the monitoring system includes at least one monitoring device having a computer processor for determining one or more analytics for aggregated assets. The computer processor has a data receiving module and a data analytics module.

In certain embodiments, the data receiving module is configured to capture via a communications network data from a plurality of assets associated with at least one entity, where the captured data have a plurality of different data file formats, and configured to store the captured data in a storage device. In certain embodiments, the data receiving module is also be configured to normalize the captured data stored in the storage device to have one or more standardized data formats.

In certain embodiments, the data analytics module is configured to analyze the normalized captured data using one or more Artificial Intelligence (AI) techniques to aggregate the captured asset data into one or more assets data sets, where each aggregated asset data set is associated with a common asset functionality. In certain embodiments, the data analytics module is configured to analyze each aggregated asset data set using one or more AI techniques to determine one or more functionality trends associated with assets in each aggregated asset data set.

In certain embodiments, the plurality of assets includes one or more of security devices (e.g., including security cameras, security door locks, security key card access panels, security biometric panels, security alarms, seismic detection systems, and/or fire detection systems), fire control or detection devices, key or key card control devices, video access devices, building access panel devices, and/or environment control systems.

In accordance with at least one aspect of this disclosure, there is provided, an artificial intelligence/machine learning (AI/ML) data aggregation module configured to aggregate and parse electronic data from a plurality of systems (e.g., which system(s) may be based on a site location/building) each including a plurality of assets/devices, for determining one or more analytics (e.g., trends) for the assets/devices. In certain embodiments, the AI/ML aggregation module is configured to receive system data directly and in real time from each of the plurality of systems through one or more communication channels and media formats.

In certain embodiments, the electronic data includes electronic communications, and the data aggregation module is configured to aggregate the received electronic communications and parse the electronic communications to be sorted into a plurality of data categories and stored in a database.

In certain embodiments, the data aggregation module is further configured to interpolate and perform analytics on the stored data using machine instructions to manage devices associated with the data and/or generate one or more user readable reports regarding the managed devices and/or other information associated with one or more of systems of the plurality of systems. In certain embodiments, the user is a device owner and/or or system administrator.

In certain embodiments, the data aggregation module is configured to perform analytics on the stored data in the database in near-real time.

In certain embodiments, the data aggregation module, when performing analytics, is configured to monitor the database for changes in information parsed from the electronic data received from the one or more devices and/or systems.

In certain embodiments, the information parsed from the electronic data received from the one or more devices and/or systems includes one or more of: device health information, device firmware information, device software information, and/or a status of the device.

In certain embodiments, the one or more user readable reports generated by the data aggregation module includes user requested report categories comprising of one or more of: health reports, status reports, maintenance reports, anomaly reports, breach reports, and/or recommendation reports regarding one or more devices associated with one or more systems specific to a respective user.

In certain embodiments, the data aggregation module is configured to perform real time pattern recognition on the database, and the user readable reports generated by the data aggregation module includes of one or more of: industry wide anomaly reports, and industry wide maintenance reports.

In certain embodiments, the data aggregation module is configured to generate device and/or system recommendations regarding one more devices and/or systems based on the one or more of: health reports, status reports, maintenance reports, anomaly reports, breach reports, industry wide anomaly reports, industry wide maintenance reports, and the recommendations is provided to a respective user.

In certain embodiments, the generated client recommendations are contingent upon industry wide anomaly reports and/or industry wide maintenance reports.

In certain embodiments, the data aggregation module is configured to generate device and/or system alerts regarding one more devices and/or systems based on the one or more of: health reports, status reports, maintenance reports, anomaly reports, breach reports, industry wide anomaly reports, industry wide maintenance reports, and the alerts are provided to a respective user.

In certain embodiments, the data aggregation module is further configured to read, parse, and interpolate user input data regarding the user owned and/or managed devices and/or systems and generate user readable reports based on both of the user input data in combination with the stored data in the database.

In certain embodiments, the data aggregation module is further configured to read, parse, and interpolate installer data and generate installer performance reports. In certain such embodiments, the data aggregation module is configured to issue installer recommendations to a respective user based on the user input data in combination with the stored data in the database and the installer data. Further, in certain such embodiments, the data aggregation module is configured to generate and issue the installer recommendations to the respective user in response to a request from the respective user.

In certain embodiments, the plurality of systems includes one or more of: a building system, a building management system, and/or a building automation system.

In certain embodiments, the plurality of devices associated with a respective system of the plurality of systems includes one or more of: security devices, fire control or detection devices, key or key card control devices, video access devices, building access panel devices, and/or environment control systems.

In certain embodiments, the plurality of systems includes a security system, and the physical devices include a plurality of security cameras, security door locks, security key card access panels, security biometric panels, security alarms, seismic detection systems, and/or fire detection systems.

In accordance with at least one aspect of this disclosure, there is provided a computer implemented management system. In certain embodiments, the computer implemented management system includes, an information intake module operatively connected to a plurality of user systems each user system having a plurality of managed physical devices associated therewith. The information intake module is configured to receive electronic information/data associated with physical devices directly from the physical devices.

In certain embodiments, the management system also includes any embodiment of the AI/ML data aggregation module described above operatively connected to the information intake module configured to aggregate and store the received information into a database.

In certain embodiments, the data aggregation module is configured to parse the information within the database to compartmentalize the information/data into one or more categories of information and perform analytics on the stored data using machine instructions to manage the physical devices associated with the plurality of user systems and/or generate one or more reports regarding the managed physical devices associated with the plurality of user systems.

In certain embodiments, the one or more reports includes health reports, status reports, maintenance reports, anomaly reports, breach reports, industry wide anomaly reports, industry wide maintenance reports. The data aggregation module is configured to issue alerts and/or recommendations a respective user based on the one or more reports. In certain embodiments, the management system is further configured to automatically track, manage, and maintain the one or more systems and/or devices associated with a respective user based on the one or more reports without a specific request from the respective user.

### BRIEF DESCRIPTION OF THE DRAWINGS

So that those skilled in the art to which the subject disclosure appertains will readily understand how to make and use the devices and methods of the subject disclosure without undue experimentation, preferred illustrated embodiments thereof will be described in detail herein below with reference to certain figures, wherein:

FIG. 1 illustrates an example communication network utilized with one or more of the illustrated embodiments;

FIG. 2 illustrates an example network device/node utilized with one or more of the illustrated embodiments;

FIG. 3 illustrates a diagram depicting an Artificial Intelligence (AI) device utilized with one or more of the illustrated embodiments;

FIG. 4 illustrates a diagram depicting an AI server utilized with one or more of the illustrated embodiments;

FIGS. 5A and 5B illustrate an exemplary embodiment of a system in accordance with this disclosure communicatively coupled to one or more client systems having one or more assets associated therewith; and

FIGS. 6-23 show exemplary illustrations of a GUI accordance with one or more of the illustrated embodiments.

FIG. 24 shows an exemplary flow chart of inputs and outputs to and from an embodiment of the data management computer system described herein.

### DETAILED DESCRIPTION

The purpose and advantages of the below described illustrated embodiments will be set forth in and apparent from the description that follows. Additional advantages of the illustrated embodiments will be realized and attained by the devices, systems and methods particularly pointed out in the written description and claims hereof, as well as from the appended drawings.

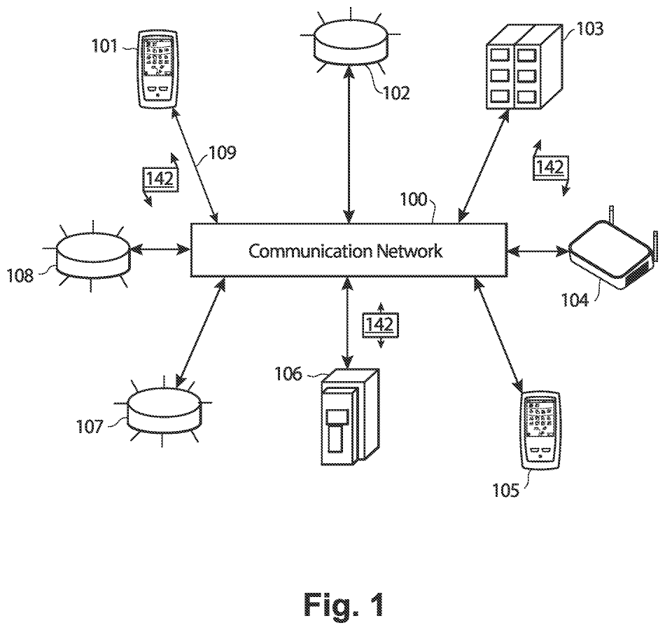

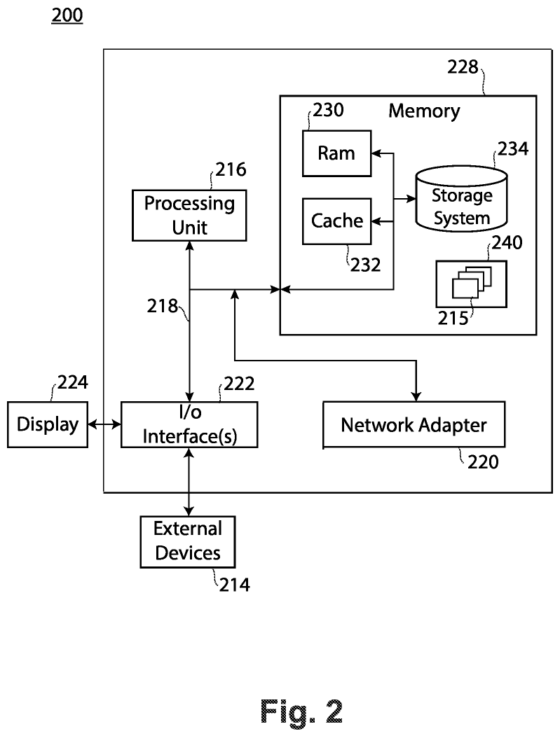

Reference will now be made to the drawings wherein like reference numerals identify similar structural features or aspects of the subject disclosure. For purposes of explanation and illustration, and not limitation, an illustrative view of an embodiment of a system in accordance with the disclosure is shown in FIG. 1 and is designated generally by reference character 100. Other embodiments and/or aspects of this disclosure are shown in FIGS. 2-24. Certain embodiments described herein provide streamlined data management for a plurality of clients having a plurality of managed assets.

The illustrated embodiments are now described more fully with reference to the accompanying drawings wherein like reference numerals identify similar structural/functional features. The illustrated embodiments are not limited in any way to what is illustrated as the illustrated embodiments described below are merely exemplary, which can be embodied in various forms, as appreciated by one skilled in the art. Therefore, it is to be understood that any structural and functional details disclosed herein are not to be interpreted as limiting, but merely as a basis for the claims and as a representation for teaching one skilled in the art to variously employ the discussed embodiments. Furthermore, the terms and phrases used herein are not intended to be limiting but rather to provide an understandable description of the illustrated embodiments.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the illustrated embodiments, exemplary methods and materials are now described.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the illustrated embodiments discussed below are preferably a software algorithm, program or code residing on computer useable medium having control logic for enabling execution on a machine having a computer processor. The machine typically includes memory storage configured to provide output from execution of the computer algorithm or program.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the illustrated embodiments based on the above-described embodiments. Accordingly, the illustrated embodiments are not to be limited by what has been particularly shown and described, except as indicated by the appended claims.

Turning now descriptively to the drawings, in which similar reference characters denote similar elements throughout the several views, FIG. 1 depicts an exemplary communications network 100 in which below illustrated embodiments may be implemented. It is to be understood a communication network 100 is a geographically distributed collection of nodes interconnected by communication links and segments for transporting data between end nodes, such as personal computers, work stations, smart phone devices, tablets, televisions, sensors and or other devices such as automobiles, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others.

FIG. 1 is a schematic block diagram of an example communication network 100 illustratively comprising nodes/devices 101-108 (e.g., sensors 102, client computing devices 103, smart phone devices 105, web servers 106, routers 107, switches 108, databases, and the like) interconnected by various methods of communication. For instance, the links 109 may be wired links or may comprise a wireless communication medium, where certain nodes are in communication with other nodes, e.g., based on distance, signal strength, current operational status, location, etc. Moreover, each of the devices can communicate data packets (or frames) 142 with other devices using predefined network communication protocols as will be appreciated by those skilled in the art, such as various wired protocols and wireless protocols etc., where appropriate. In this context, a protocol consists of a set of rules defining how the nodes interact with each other. Those skilled in the art will understand that any number of nodes, devices, links, etc. may be used in the computer network, and that the view shown herein is for simplicity. Also, while the embodiments are shown herein with reference to a general network cloud, the description herein is not so limited, and may be applied to networks that are hardwired.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the illustrated embodiments are described below with reference to flowchart illustrations and/or block diagrams of methods, apparatus (systems) and computer program products according to the illustrated embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

FIG. 2 is a schematic block diagram of an example network computing device 200 (e.g., client computing device 103, server 106, etc.) that may be used (or components thereof) with one or more embodiments described herein, e.g., as one of the nodes shown in the network 100. As explained above, in different embodiments these various devices are configured to communicate with each other in any suitable way, such as, for example, via communication network 100.

Device 200 is intended to represent any type of computer system capable of carrying out the teachings of various illustrated embodiments. Device 200 is only one example of a suitable system and is not intended to suggest any limitation as to the scope of use or functionality of the illustrated embodiments described herein. Regardless, computing device 200 is capable of being implemented and/or performing any of the functionality set forth herein.

Computing device 200 is operational with numerous other general purpose or special purpose computing system environments or configurations. Examples of well-known computing systems, environments, and/or configurations that may be suitable for use with computing device 200 include, but are not limited to, personal computer systems, server computer systems, thin clients, thick clients, hand-held or laptop devices, multiprocessor systems, microprocessor-based systems, set top stepes, programmable consumer electronics, network PCs, minicomputer systems, and distributed data processing environments that include any of the above systems or devices, and the like. Computing device 200 may be described in the general context of computer system-executable instructions, such as program modules, being executed by a computer system. Generally, program modules may include routines, programs, objects, components, logic, data structures, and so on that perform particular tasks or implement particular abstract data types. Computing device 200 may be practiced in distributed data processing environments where tasks are performed by remote processing devices that are linked through a communications network. In a distributed data processing environment, program modules may be located in both local and remote computer system storage media including memory storage devices. In accordance with the illustrated embodiments, computing device 200 is preferably configured and operative to communicate and receive data from a plurality of client systems for managing electronic data associated with a plurality of clients for intelligently aggregating data associated with one or more of the clients, wherein the received electronic data relates to one or more assets and/or other information associated with one or more of the clients for performing data analytics using machine instructions for managing the assets and/or generating one or more user readable reports regarding the managed assets and/or other information associated with one or more of the clients.

The components of device 200 may include, but are not limited to, one or more processors or processing units 216, a system memory 228, and a bus 218 that couples various system components including system memory 228 to processor 216. Bus 218 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. Computing device 200 typically includes a variety of computer system readable media. Such media may be any available media that is accessible by device 200, and it includes both volatile and non-volatile media, removable and non-removable media.

System memory 228 can include computer system readable media in the form of volatile memory, such as random access memory (RAM) 230 and/or cache memory 232. Computing device 200 may further include other removable/non-removable, volatile/non-volatile computer system storage media. By way of example only, storage system 234 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 218 by one or more data media interfaces. As will be further depicted and described below, memory 228 may include at least one program product having a set (e.g., at least one) of program modules that are configured to carry out the functions of embodiments of illustrated embodiments.

Program/utility 240, having a set (at least one) of program modules 215, such as underwriting module, may be stored in memory 228 by way of example, and not limitation, as well as an operating system, one or more application programs, other program modules, and program data. Each of the operating system, one or more application programs, other program modules, and program data or some combination thereof, may include an implementation of a networking environment. Program modules 215 generally carry out the functions and/or methodologies of the illustrated embodiments as described herein, including, but not limited to information intake, aggregation of information into computer readable data, compartmentalization of data, parsing, analyzing, and performing pattern recognition on the data to convert the data into a more user readable format preferably for managing electronic data associated with a plurality of clients for intelligently aggregating data associated with one or more of the clients. The received electronic data relates to one or more assets and/or other information associated with one or more of the clients for performing data analytics using machine instructions for managing the assets and/or generating one or more user readable reports regarding the managed assets and/or other information associated with one or more of the clients.

Device 200 may also communicate with one or more external devices 214 such as a keyboard, a pointing device, a display 224, etc.; one or more devices that enable a user to interact with computing device 200; and/or any devices (e.g., network card, modem, etc.) that enable computing device 200 to communicate with one or more other computing devices. Such communication can occur via Input/Output (I/O) interfaces 222. Still yet, device 200 can communicate with one or more networks such as a local area network (LAN), a general wide area network (WAN), and/or a public network (e.g., the Internet) via network adapter 220. As depicted, network adapter 220 communicates with the other components of computing device 200 via bus 218. It should be understood that although not shown, other hardware and/or software components could be used in conjunction with device 200. Examples, include, but are not limited to: microcode, device drivers, redundant processing units, external disk drive arrays, RAID systems, tape drives, and data archival storage systems, etc.

FIGS. 1 and 2 are intended to provide a brief, general description of an illustrative and/or suitable exemplary environment in which the below described illustrated embodiments may be implemented. FIGS. 1 and 2 are exemplary of a suitable environment and are not intended to suggest any limitation as to the structure, scope of use, or functionality of an illustrated embodiment. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

It is to be understood the embodiments described herein are preferably provided with self-learning/Artificial Intelligence (AI) for data analysis in accordance with the illustrated embodiments. Thus, the computer system 200 is preferably integrated into an AI system (as also described below) that is preferably coupled to a plurality of external databases/data sources that implements machine learning and artificial intelligence algorithms in accordance with the illustrated embodiments. For instance, the AI system may include two subsystems: a first sub-system that learns from historical data; and a second subsystem to identify and recommend one or more parameters or approaches based on the learning. It should be appreciated that although the AI system may be described as two distinct subsystems, the AI system can also be implemented as a single system incorporating the functions and features described with respect to both subsystems.

Also in accordance with the illustrated embodiments, an artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value. The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function. The purpose of the learning of the artificial neural network may be to determine the model parameters that minimize a loss function. The loss function may be used as an index to determine optimal model parameters in the learning process of the artificial neural network. Machine learning may be classified into supervised learning, unsupervised learning, and reinforcement learning according to a learning method. The supervised learning may refer to a method of learning an artificial neural network in a state in which a label for learning data is given, and the label may mean the correct answer (or result value) that the artificial neural network must infer when the learning data is input to the artificial neural network. The unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep learning is part of machine learning.

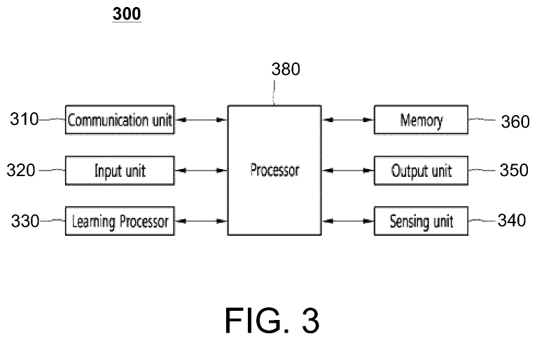

FIG. 3 illustrates an AI device 300 according to an embodiment of the present invention. The AI device 300 may be implemented by a stationary device or a mobile device, such as a smartphone, a desktop computer, a notebook, a digital broadcasting terminal, a personal digital assistant (PDA), a tablet PC, a desktop computer, and the like.

Referring to now FIG. 3, in conjunction with FIGS. 1 and 2, the AI device 300 is operatively coupled to, or integrated with computing device 200, in accordance with the illustrated embodiments described herein. AI device 300 preferably includes a communication unit 310, an input unit 320, a learning processor 330, a sensing unit 340, an output unit 350, a memory 370, and a processor 380. The communication unit 310 may transmit and receive data to and from external devices such as other AI devices 300a to 300e and the AI server 400 by using wire/wireless communication technology. For example, the communication unit 310 may transmit and receive sensor information, a user input, a learning model, and a control signal to and from external devices.

The communication technology used by the communication unit 310 preferably includes GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Data Association (IrDA), ZigBee, NFC (Near Field Communication), and the like.

The input unit 320 may acquire various kinds of data, including, but not limited to system information, asset information including asset health, asset performance, asset triggers, client specific data, client input data, among others. The input unit 320 may acquire a learning data for model learning and an input data to be used when an output is acquired by using learning model. The input unit 320 may acquire raw input data. In this case, the processor 380 or the learning processor 330 may extract an input feature by preprocessing the input data. The learning processor 330 may learn a model composed of an artificial neural network by using learning data. The learned artificial neural network may be referred to as a learning model. The learning model may be used to an infer result value for new input data rather than learning data, and the inferred value may be used as a basis for determination to perform a certain operation.

At this time, the learning processor 330 may perform AI processing together with the learning processor 330 of the AI server 400, and the learning processor 330 may include a memory integrated or implemented in the AI device 300. Alternatively, the learning processor 330 may be implemented by using the memory 370, an external memory directly connected to the AI device 300, or a memory held in an external device. The sensing unit 340 may acquire at least one of internal information about the AI device 300, ambient environment information about the AI device 300, and user information by using various sensors.

The output unit 350 preferably includes a display unit for outputting/displaying relevant information to a user in accordance with the illustrated embodiments described herein. The memory 370 preferably stores data that supports various functions of the AI device 300. For example, the memory 370 may store input data acquired by the input unit 320, learning data, a learning model, a learning history, and the like.

The processor 380 preferably determines at least one executable operation of the AI device 300 based on information determined or generated by using a data analysis algorithm or a machine learning algorithm. The processor 380 may control the components of the AI device 300 to execute the determined operation. To this end, the processor 380 may request, search, receive, or utilize data of the learning processor 330 or the memory 370. The processor 380 may control the components of the AI device 300 to execute the predicted operation or the operation determined to be desirable among the at least one executable operation. When the connection of an external device is required to perform a determined operation, the processor 380 may generate a control signal for controlling the external device and may transmit the generated control signal to the external device. The processor 380 may acquire intention information for the user input and may determine the user's requirements based on the acquired intention information.

The processor 380 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 330, may be learned by the learning processor 340 of the AI server 400, or may be learned by their distributed processing. The processor 380 may collect history information including the operation contents of the AI device 300 or the user's feedback on the operation and may store the collected history information in the memory 370 or the learning processor 330 or transmit the collected history information to the external device such as the AI server 400. The collected history information may be used to update the learning model.

The processor 380 may control at least part of the components of AI device 300 so as to drive an application program stored in memory 370. Furthermore, the processor 380 may operate two or more of the components included in the AI device 300 in combination so as to drive the application program.

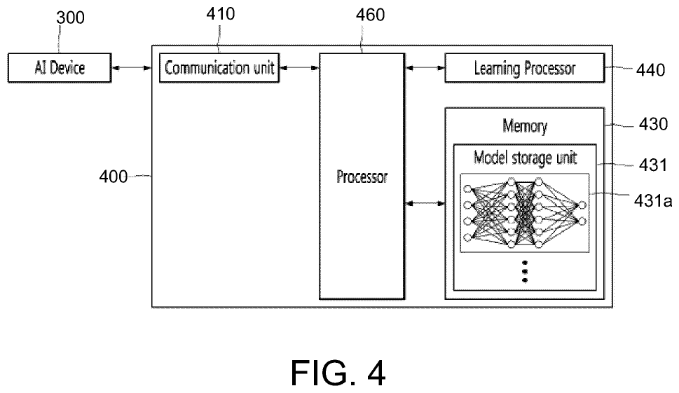

FIG. 4 illustrates an AI server 400 according to the illustrated embodiments. It is to be appreciated that the AI server 400 may refer to a device that learns an artificial neural network by using a machine learning algorithm or uses a learned artificial neural network. The AI server 400 may include a plurality of servers to perform distributed processing, or may be defined as a 5G network. At this time, the AI server 400 may be included as a partial configuration of the AI device 300, and may perform at least part of the AI processing together. The AI server 400 may include a communication unit 410, a memory 430, a learning processor 440, a processor 460, and the like. The communication unit 410 can transmit and receive data to and from an external device such as the AI device 300. The memory 430 may include a model storage unit 431. The model storage unit 431 may store a learning or learned model (or an artificial neural network 431a) through the learning processor 440.

The learning processor 440 may learn the artificial neural network 431a by using the learning data. The learning model may be used in a state of being mounted on the AI server 400 of the artificial neural network, or may be used in a state of being mounted on an external device such as the AI device 300. The learning model may be implemented in hardware, software, or a combination of hardware and software. If all or part of the learning models are implemented in software, one or more instructions that constitute the learning model may be stored in memory 430. The processor 460 may infer the result value for new input data by using the learning model and may generate a response or a control command based on the inferred result value.

With the exemplary communication network 100 (FIG. 1), computing device 200 (FIG. 2), AI device 300 (FIG. 3) and AI server 400 (FIG. 4) being generally shown and discussed above, description of certain illustrated embodiments will now be provided.

It is to be understood and appreciated that exemplary embodiments implementing one or more components of FIGS. 1-4 relate to data management system as shown and described. It is to be appreciate and understood that certain embodiments described below are described in regard to centralized management of security systems, which is provided for illustrating purposes only as the data management system and method in accordance with the illustrated embodiments is not to be limited to such security systems as it encompasses any applicable enterprise system having preferably a plurality of geographically dispersed assets/devices (including inventory) and a plurality of data types and formats. It is to be understood and appreciated that FIGS. 1-4 are intended to provide a brief, general description of an illustrative and/or suitable exemplary environment in which the below described illustrated embodiments may be implemented. FIGS. 1-4 are exemplary of a suitable environment and are not intended to suggest any limitation as to the structure, scope of use, or functionality of an illustrated embodiment. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

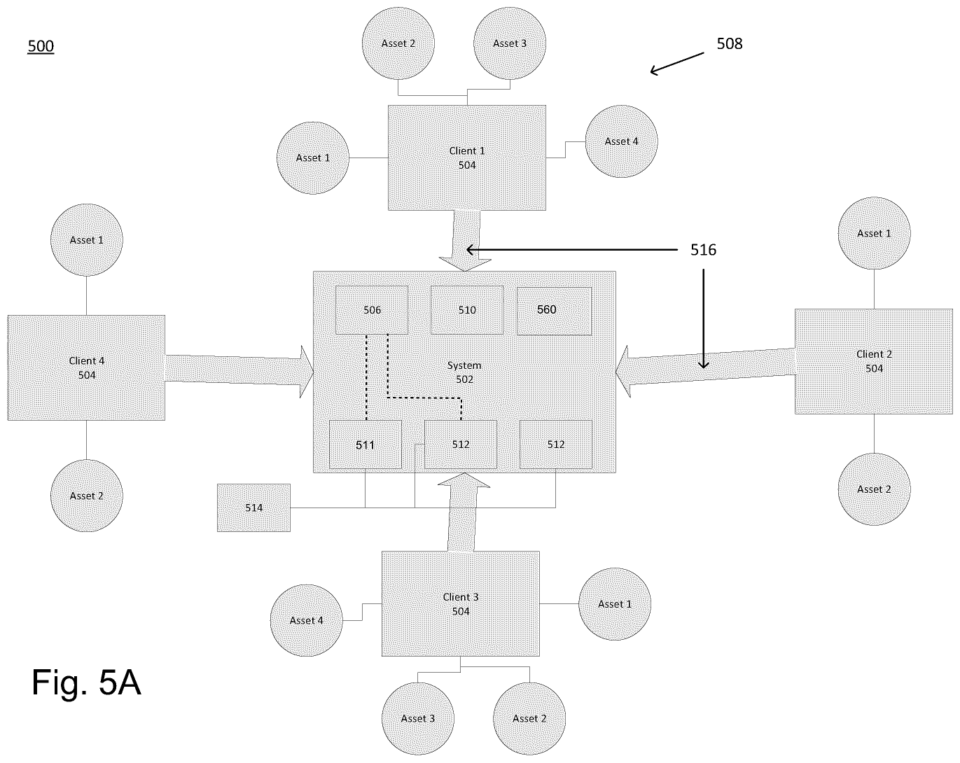

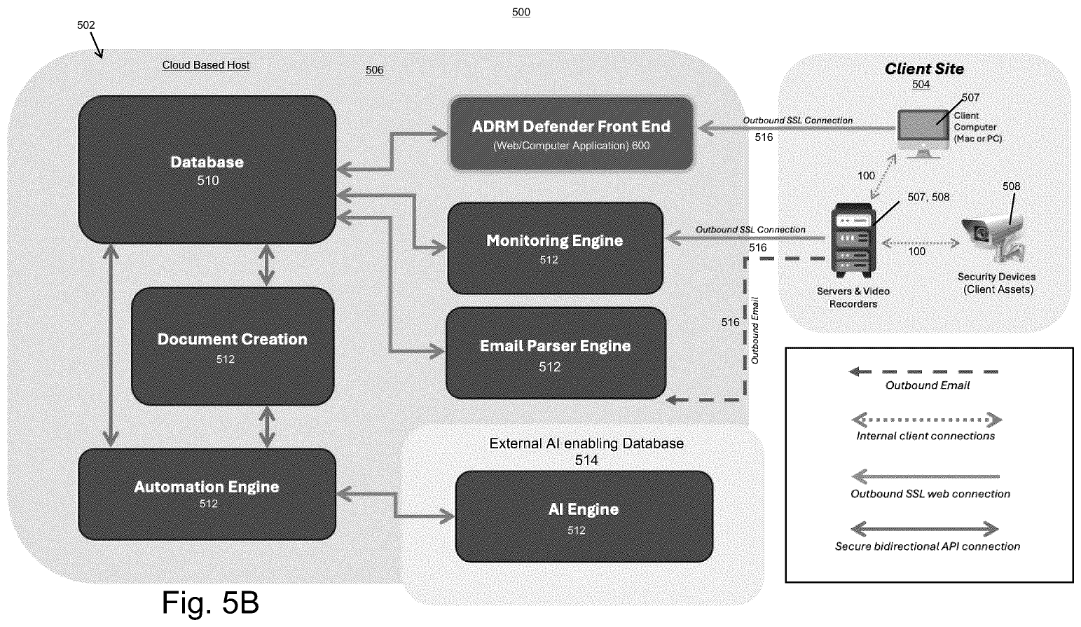

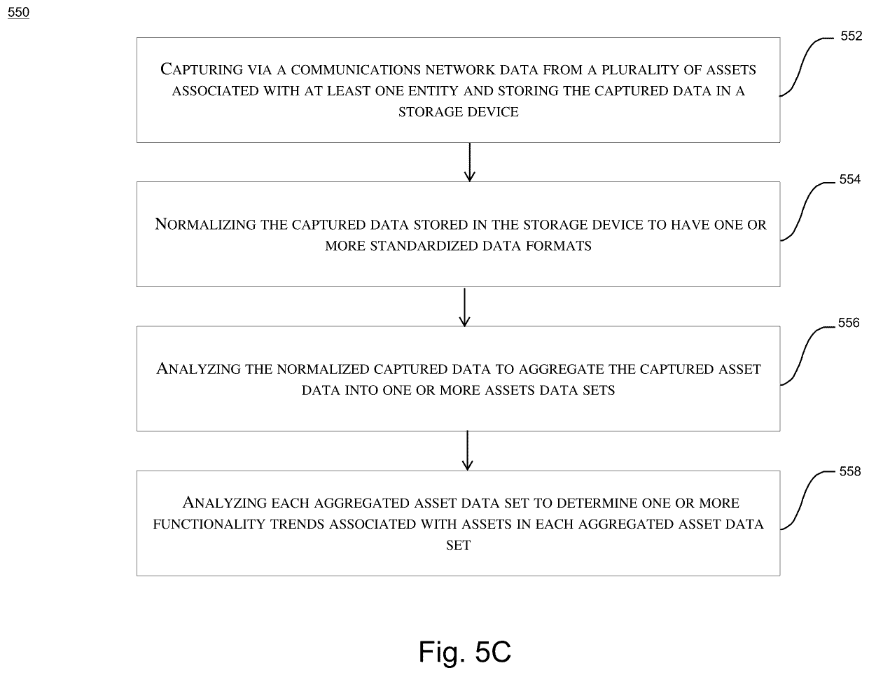

With the exemplary communication network 100 (FIG. 1), computing device 200 (FIG. 2), AI device 300 (FIG. 3) and AI server 400 (FIG. 4) being generally shown and discussed above, description of certain illustrated embodiments will now be provided. With reference now to FIG. 5, shown is an exemplary embodiment of a data management system, utilizing one or more of the aforementioned communication network 100 (FIG. 1), computing device 200 (FIG. 2), AI device 300 (FIG. 3) and AI server 400 (FIG. 4).

In accordance with at least one aspect of this disclosure, as shown in FIGS. 5A-5B, a monitoring system 500 is provided. In certain embodiments, the monitoring system includes at least one monitoring device 502 having a computer processor 560 for determining one or more analytics for aggregated assets 508. The computer processor 560 has a data receiving module 511 and at least one data analytics module 512.

In certain embodiments, the data receiving module 511 is configured to capture, via a communications network (e.g., connection 516), data from a plurality of assets 508 associated with at least one entity 504. In certain embodiments, the network uses a LoRaWAN network. The at least one entity sends data from any number of devices, e.g., directly from entity computer devices 507, entity servers or recording devices 507, 508, or entity owned assets 508. In certain embodiments, the data from the entity assets 508 is passed through the client computerized devices 507 before being captured by the receiving module 511. In certain embodiments, the captured data have a plurality of different data file formats (e.g., because the captured date may be coming from a plurality of different device types). In certain embodiments, the data file formats include either binary or text-based files. The data receiving module is also configured to store the captured data in a storage device (e.g., database 510). In certain embodiments, the data receiving module 511 is also configured to normalize the captured data stored in the storage device 510 to have one or more standardized data formats.

In certain embodiments, the data analytics module 512 is configured to analyze the normalized captured data using one or more Artificial Intelligence (AI) techniques (e.g., via connection to an external database 514) to aggregate the captured asset data into one or more assets data sets, where each aggregated asset data set is associated with a common asset functionality. For example, the common asset functionality includes, cameras configured for video monitoring (object recognition, motion detection), door sensors configured for door monitoring (open times, close times), keypad/door locks configured for access monitoring (scans), alarms configured for monitoring security incidents (trigger times, duration), or the like. In certain embodiments, the data analytics module 512 can further be configured to analyze each aggregated asset data set using one or more AI techniques to determine one or more functionality trends associated with assets in each aggregated asset data set. For example, the functionality trends include, in certain embodiments, health trends and anomalies, APIs such as length of time a door is held open, a door is forced open, trends around security incidents such as circumstances around an alarm trigger, nuisance alarms, redundant alarms, camera tampering, hardware tampers, or trends relating to data loss such as database loss, interface suddenly offline, unit connection loss, sync fail, roll stopped unexpectedly, and the like.

In certain embodiments, the monitoring system 500 is one of a building system, a building management system, and/or a building automation system, and/or a security monitoring system and the plurality of assets 508 includes of one or more of security devices (e.g., including security cameras, security door locks, security key card access panels, security biometric panels, security alarms, seismic detection systems, and/or fire detection systems), fire control or detection devices, key or key card control devices, video access devices, building access panel devices, and/or environment control systems.

Still with reference to FIGS. 5A and 5B, the system 500 includes, in accordance with at least one aspect of this disclosure, a data management computer system 502 and method for managing electronic data associated with a plurality of clients (e.g., companies, enterprises and the like) 504. FIG. 5A shows an example where a plurality of clients are connected to the system 500. FIG. 5B shows a more detailed schematic than that shown in FIG. 5A. While FIG. 5B shows only one client site 504 connected to the system 500, it will be appreciated by one having ordinary skill in the art in view of this disclosure that the connection shown between the client 504 and system 500 in FIG. 5B is the same for any number of clients. In certain embodiments, the system 502 (e.g., including one or more components of computer device 200 of FIG. 2) preferably includes a data aggregator 506 configured to receive electronic data, via one or more computer networks (e.g., computer network 100), from computer systems 507 associated with one or more of the plurality of clients 504. The received electronic data relates to one or more assets 508 and/or other information associated with one or more of the plurality of clients and the data aggregator is configured to aggregate the received electronic data into a plurality of data categories.

The system includes a database 510 configured to store the aggregated data and further includes one or more analytical modules 512 for performing analytics on the stored data using machine instructions to manage assets associated the data and/or generate one or more user readable reports regarding the managed assets and/or other information associated with one or more of the plurality of clients.

In embodiments, the one or more analytical modules includes one or more artificial intelligence and/or machine learning (AI/ML) modules (e.g., FIGS. 3 and 4) configured to interpolate data stored in the database and generate user readable reports for one or more report categories using one or more AI/ML techniques. In embodiments, the analytics performed on the data stored in the database is defined by the one or more AI/ML modules.

In embodiments, the one or more analytical modules is communicatively coupled to one or more external databases 514 for enabling the one or more AI/ML modules to interpolate the data stored in the database to manage assets associated with a certain client and/or generate user readable reports for one or more report categories.

In embodiments, at least one or more of the plurality of data categories is defined by the one or more AI/ML modules (e.g., FIGS. 3 and 4). In certain embodiments, the plurality of data categories is user-defined and based on user preferences.

In embodiments, at least a portion of the received data is encrypted and the encrypted data is decrypted prior to being subject to the analytical processing in the one more analytical modules 512.

In certain embodiments, at least a portion of the client assets 508 include physical assets. In certain embodiments, at least a portion of the physical assets 508 include security related assets. In certain embodiments, the physical security assets includes a plurality of: security cameras, security door locks, security key card access panels, security biometric panels, security alarms, seismic detection systems, and/or fire detection systems, or the like. For example, each client has any number of security assets associated therewith, and any number of categories or kinds of security assets associated therewith. While not every possible asset is listed herein, one having ordinary skill in the art in view of this disclosure would readily appreciate that the systems and methods described herein are applicable to other types of assets, including safety assets (fire detection, chemical detection, or the like), or other monitoring systems that are not necessarily categorized by security or safety.

In accordance with at least one aspect of this disclosure, such as shown in FIG. 5C, a computer-implemented method 550 for a monitoring device (e.g., device 502) having a computer processor for determining one or more analytics for aggregated assets is provided.

In certain embodiments, the method 550 includes in step 552 capturing, by the computer processor, via a communications network, data from a plurality of assets associated with at least one entity. The captured data has a plurality of different data file formats. Still ay step 552, the method 550 includes storing the captured data, by the computer processor, in a storage device (e.g., a database 510). At step 554, the method includes normalizing the captured data stored in the storage device, by the computer processor, to have one or more standardized data formats.

The method further comprises, e.g., at step 556, analyzing, by the computer processor, the normalized captured data using one or more AI techniques to aggregate the captured asset data into one or more assets data sets, where each aggregated asset data set is associated with a common asset functionality. At step 558, the method further includes, analyzing, by the computer processor, using one or more AI techniques, each aggregated asset data set to determine one or more functionality trends associated with assets in each aggregated asset data set.

In certain embodiments, the one or more AI techniques applies one or more AI models to the normalized captured asset data for classifying the normalized captured asset data so as to be aggregated into the one or more assets data sets.

In certain embodiments, the one or more AI techniques applies one or more AI models to the one or more asset data sets for determining the one or more functionality trends associated with assets in each aggregated asset data set.

In certain embodiments, the functionality trends include performance metrics according to prescribed criteria. The prescribed criteria include, in certain embodiments, suitable operating conditions, geographic location, installation location, hardware conditions and status, software conditions and status, predictive and preventive maintenance. An example of a specific performance metric criteria for risk assessment is predictive and preventative maintenance, which can include recording external or internal events that may indicate a subsequent failure of the asset, such as monitoring CPU spikes, sudden connection losses, sync failures, or the like. These events may indicate that a server will soon fail and a client should consider replacing one or more components of the system.

In certain embodiments, the plurality of assets includes one or more of security devices (e.g., including security cameras, security door locks, security key card access panels, security biometric panels, security alarms, seismic detection systems, and/or fire detection systems), fire control or detection devices, key or key card control devices, video access devices, building access panel devices, and/or environment control systems.

In certain embodiments, the captured data includes operational data (for example, nuisance alarms, redundant alarms, or the like) associated with a specific asset. In certain embodiments, the captured operational data is captured in real-time and the method is performed continuously and automatically while data is captured from the assets.

In accordance with at least one aspect of this disclosure, e.g., as shown in FIGS. 5A to 5C, a non-transitory computer readable medium having computer executable instructions configured to cause a computer to perform a method is provided. In certain embodiments, the method is a method for a monitoring device having a computer processor for determining one or more analytics for aggregated assets. In certain embodiments, the method is as described hereinabove.

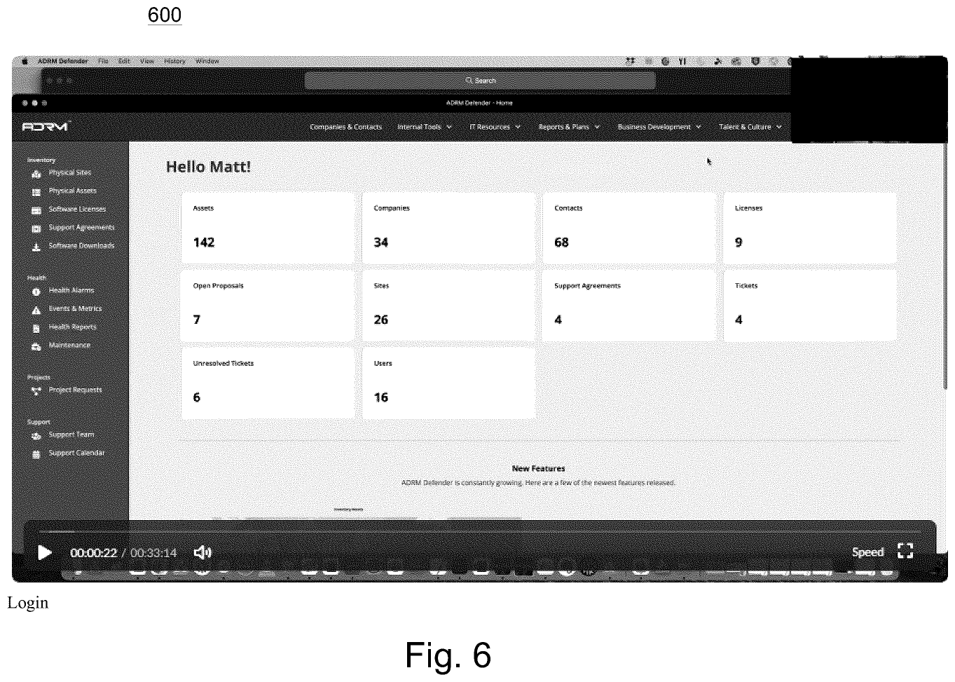

In embodiments, the system 502 further includes means for generating a graphical user interface (GUI) 600 for display on a display screen of a user device, such as shown in FIGS. 6-23. For example, the graphical user interface 600 is configured for display in a window occupying all or a portion of the display screen comprising a first frame occupying a first frame region of the window. The first frame illustrates an overview of the aggregated categorized information associated with one or more of the plurality of clients, such as shown in FIG. 6. In certain embodiments, the first frame is accessible on a user computing device associated with a system administrator and may not be accessible by any of the plurality of clients.

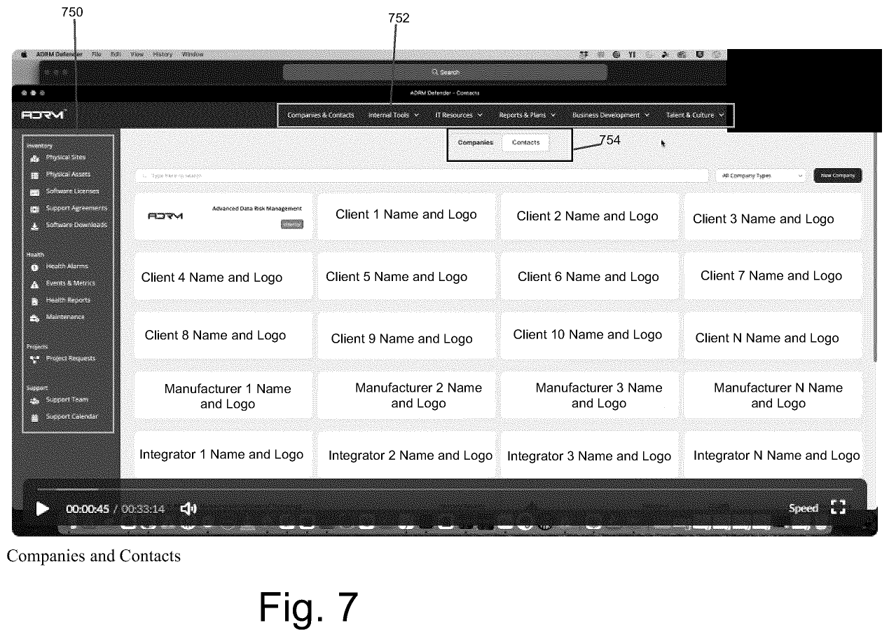

In embodiments, the system/method includes generating a GUI configured for display in a window occupying all or a portion of the display screen comprising a first frame occupying a first frame region of the window The first frame illustrates an overview of the aggregated categorized information associated with a certain client or of all clients of the one or more of the plurality of clients. In embodiments, the frame includes a listing of user selectable clients such as shown in FIG. 7. Specific aspects of the GUI will be discussed in greater detail later in the description.

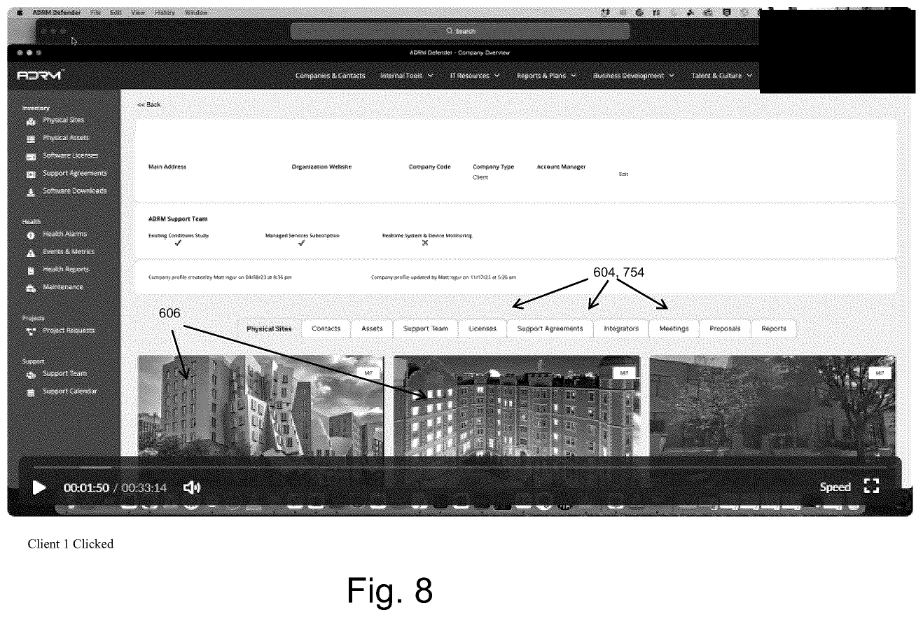

In certain embodiments, as shown in FIG. 8, the first frame also includes a plurality of user selectable options 604, including one or more of: a listing of assets, a listing of management meetings and associated minutes, a listing of client proposals, a listing of client generated reports and management generated reports, a listing of performance reports and/or performance recommendations.

In embodiments, the listing of assets include a listing of physical locations at which an asset is installed. This can be seen in FIG. 8, as the currently selected option. In certain embodiments, the listing of assets include a listing of physical security system assets installed at one or more physical locations. In certain embodiments, the listing of assets include a listing of assets stored in inventory on or offsite.

In embodiments, the listing of physical locations at which a security system is installed further includes one or more graphical images 606 of the physical locations and/or graphical images of a respective physical asset installed in the physical location. In embodiments, the image is a generic representative image, such as a zoomed-out view of a building in or one which the asset is installed (such as shown in FIG. 8), or the graphical image includes an image of the actual asset installed in its actual location (which is useful for repairing or replacing the asset to ensure the correct vantage is set).

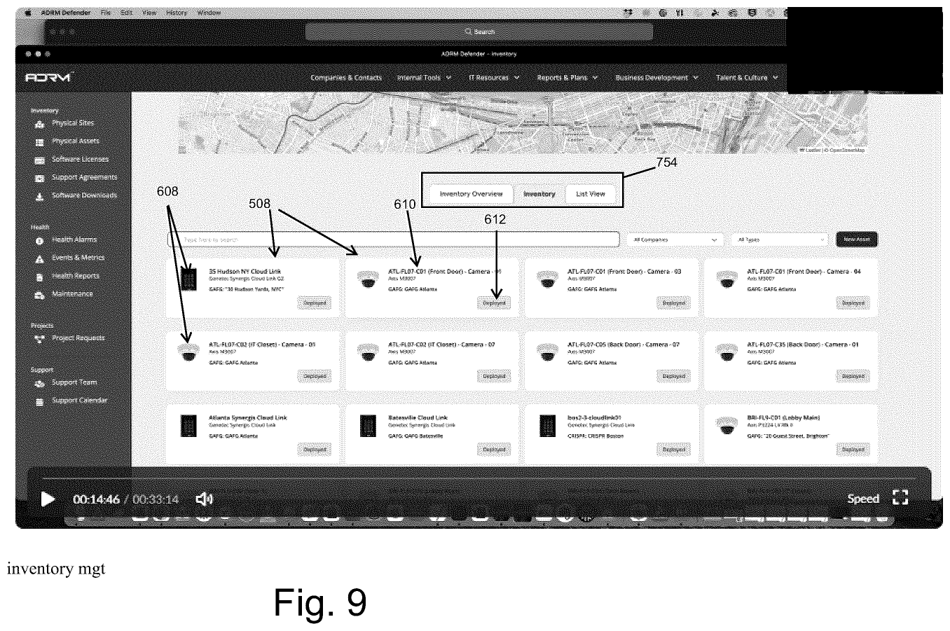

In embodiments, as shown in FIG. 9, the listing of physical security assets includes graphical representation of each respective physical security asset 508 within the listing and visual 608 and textual information 610 associated with the respective asset 508, for example in connection with an inventory management module, which will be discussed further below. In certain embodiments, the visual 608 and textual 610 information associated with the respective asset includes, at least: color indictors 612 for identifying a status of the asset, textual information 610 identifying a name of the asset, and/or textual information 610 identifying a model number of the asset. The visual information 608 includes images of a representative of a physical asset.

In certain embodiments, the electronic data 516 is received in real time from the plurality of clients 504 and the analytics performed on the data in the database is performed in near-real time, and the near real-time data analysis updates the GUI accordingly in near real-time so that clients easily see the status of the system, for example, as the system experiences changes. In embodiments, the one or more AI/ML modules 512 is configured to monitor the database for changes in the information received from the one or more clients, which includes changes in inventory, changes in an asset (e.g., removal or replacement), changes in provider, or other client data provided data.

In certain embodiments, the system 502 includes an inventory module, which is accessed by a user from the selectable options on the GUI, a portion of which is shown in FIG. 8. The inventory module is a system administrator level inventory, which shows all inventory for all clients. The inventory module is also client specific, wherein a specific client views only their own inventory, while the AI/ML modules are configured to manage the client specific inventory by providing real time inventory count or changes in response to actions taken by a client. For example, if a client installs a new asset 508 from inventory, the client scans a barcode associated with the asset and the AI/ML modules 512 automatically decrements the client inventory based on the scan as well as cause a printer to print a physical label for labeling the asset. The inventory module therefore provides clients and system administrators with live inventory tracking as new assets are purchased and stored (incremented), as well as deployed (decremented). FIGS. 9-11 show representative images of a system administrator view of the GUI for portions of the inventory module. A client view of the GUI is the same or similar but will preferably be limited to only the client's assets.

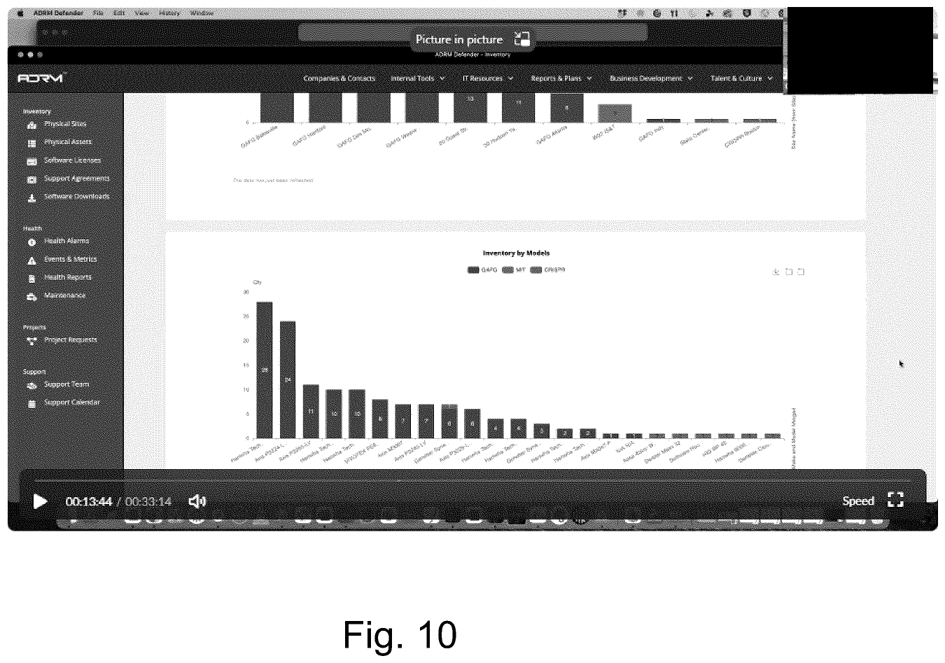

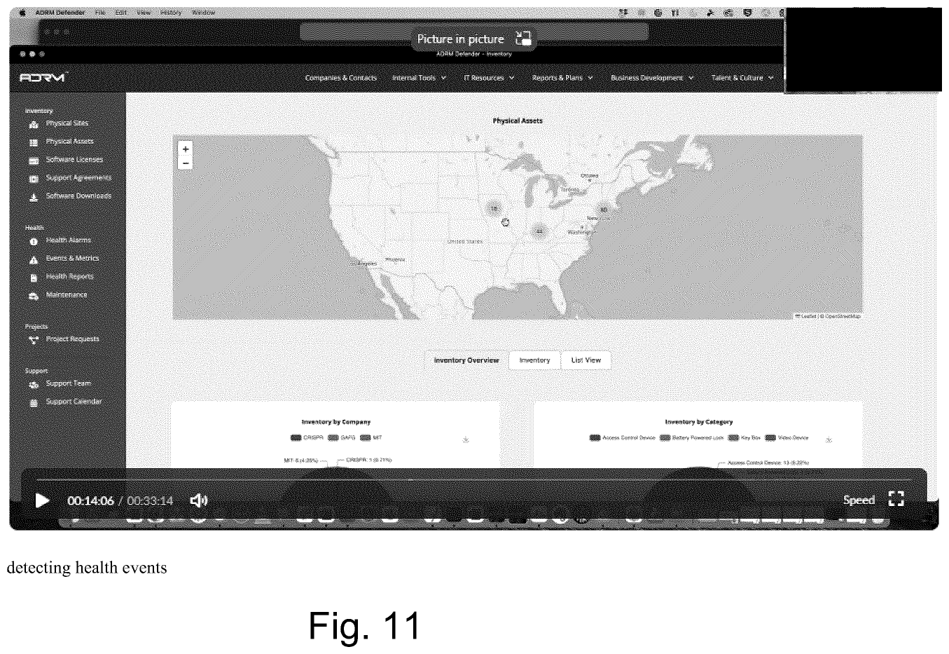

FIG. 9 shows a client's inventory and their status, which can be viewed by a client or a system administrator. FIG. 10 shows a system administrator view of inventory held by all clients, where asset model is on the x-axis, and inventory quantity is shown on the y-axis. The colors shown on each bar represent the selected clients chosen for comparison. In this way, system administrators can view single client inventory in a graphical format or can view inventory for any number of clients at the same time for easy comparison. The AI/ML modules also perform analysis on the filtered data and generate reports relating thereto which can help assist clients with decision making regarding system upgrades or changes based on peer companies, for example. FIG. 11 shows a graphical view of assets deployed in a geographical location. The map view shows hotspots as to where assets are physically located. The inventor module also provides an overview of inventory generally, by category or by client, among others. The inventory module is filtered by selecting any number of clients to view and/or compare. In the example of FIG. 11, the system administrator has opened the inventor module with three clients selected. Embodiments of the map view are zoomed to show more precise locations of the installed assets on the map down to the building, for example.

In embodiments, the information received from the plurality of assets 508 include of one or more of: health information, firmware information, software information, and/or a status of the asset. In embodiments, the information received from the assets 508 may be indicative of certain asset conditions, which are recognized and categorized by the system 502, and analytical modules 512. For example, continuous power cycling data received from the asset 508 may be indicative of a health condition or a software condition which the analytical modules 512 recognize and ultimately notify the client or system administrator to take action if necessary based on the information received from the asset(s).

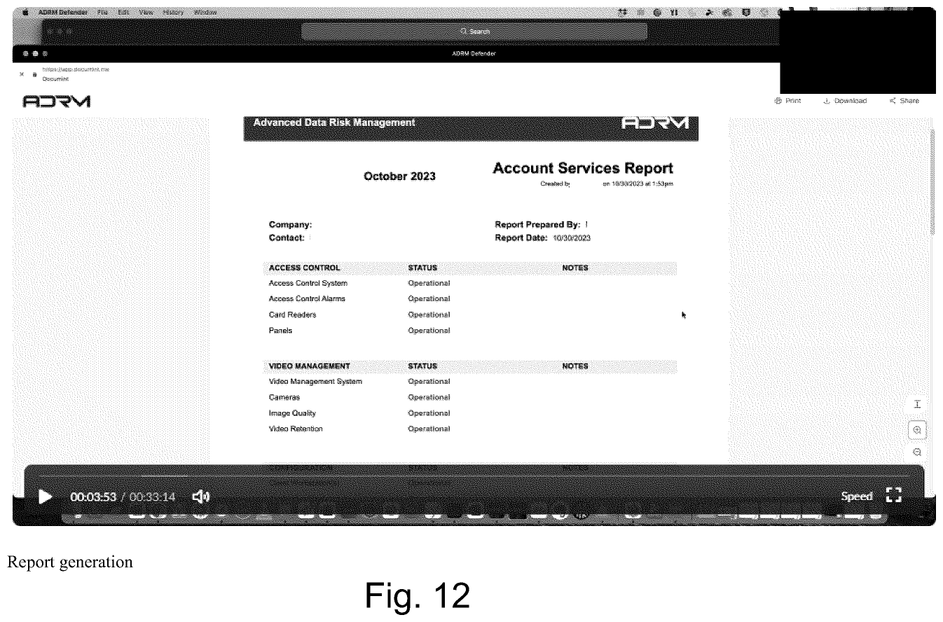

In embodiments, with the asset information discussed in the preceding paragraph, the one or more analytical modules 512 analyze the aggregate asset information and generate one or more user readable reports, including requested reports from categories including one or more of: health reports, status reports, maintenance reports, anomaly reports, breach reports, and/or recommendation reports regarding one or more assets associated with one or more clients. For example, in addition to the system 502 automatically providing reports to the one or more clients based on aggregated data for all clients and all assets, a client specifically requests a report be generated. This can be seen in FIG. 12 for example, where a client has requested an account services report. The report shows, among other things, a status of the client's respective systems, and in this example, including access control systems and alarms, card access readers, and security video systems. The report indicates that each system is operational and includes textual information to that affect, along with color indication to help a user quickly identify any concerns.

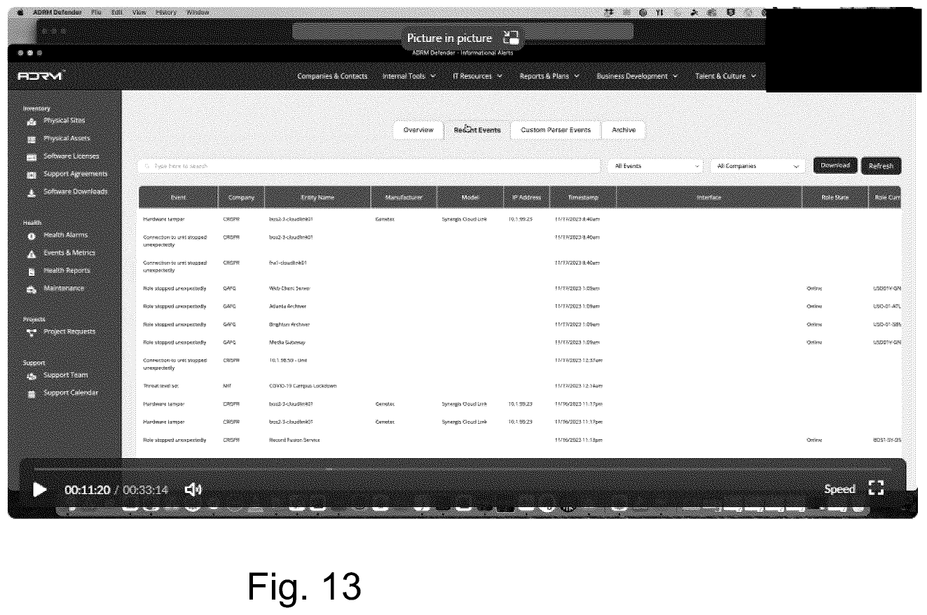

As shown in FIG. 13, the system 502 also preferably provides clients with real time, or near real time reports of each asset within a system, preferably as changes occur. Examples of changes shown in FIG. 13 include, among others, hardware tamper, connection to unit stopped unexpectedly, and power stopped unexpectedly. Each event entry includes identifying information about the asset, as well as a time stamp for the occurrence. The example of the report shown in FIG. 13 is a system administrator generated report, where the system administrator receives real time or near real time changes for assets across all clients, while a client viewing the same report would view activity for their own assets.

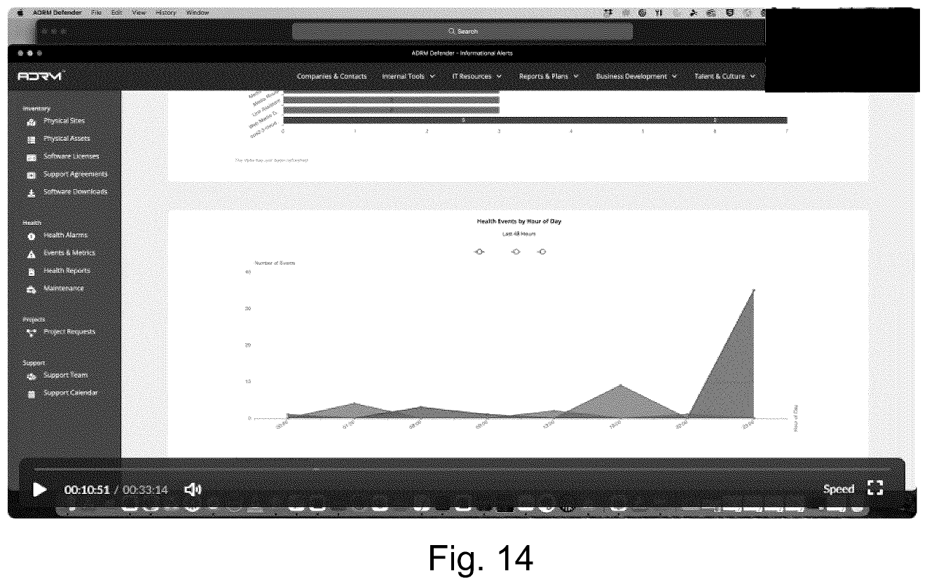

In certain embodiments, the one or more AI/ML modules 512 are preferably configured to perform real time pattern recognition on the database 510, and the generated user readable reports preferably includes one or more of: industry wide anomaly reports, industry wide maintenance reports. For example, if a user is interested in learning about how a particular asset performs in general, the anomaly reports could provide the client with insights to assist in decision making about system upgrades or may provide insights as to whether other clients are experiencing similar anomalies. These reports could also be used by system administrators to monitor anomalies across all clients, to develop the industry wide reports. This is seen, for example in FIG. 14, where the graph shows health events by hour per day for three difference clients (each client shown in a different color). This data is utilized by the AI/ML modules to generate health reports for the specific client with respect to their own assets, as well as in view of all assets owned by other clients in aggregate. FIG. 14 is a representative image, however, any suitable graphical representations showing health events, can be generated in accordance with this disclosure.

In certain embodiments, the one or more analytical modules are preferably configured and operative to detect software and/or firmware updates available for one or more assets associated with a certain client. For example, in embodiments, the one or more AI/ML modules 512 are configured to generate client recommendations regarding one more assets associated with a certain client, for example, in view of the reports discussed above with respect to the industry wide data analysis. In certain embodiments, the generated client recommendations are contingent upon industry wide anomaly reports and/or industry wide maintenance reports, for example, to recommend to clients having a particular camera model that said model should be replaced with an updated model. Another recommendation could be to not upgrade to a particular model due to observed increased health incidents in the newer model, or, to update or not update asset software due to observed bug issues, for example.

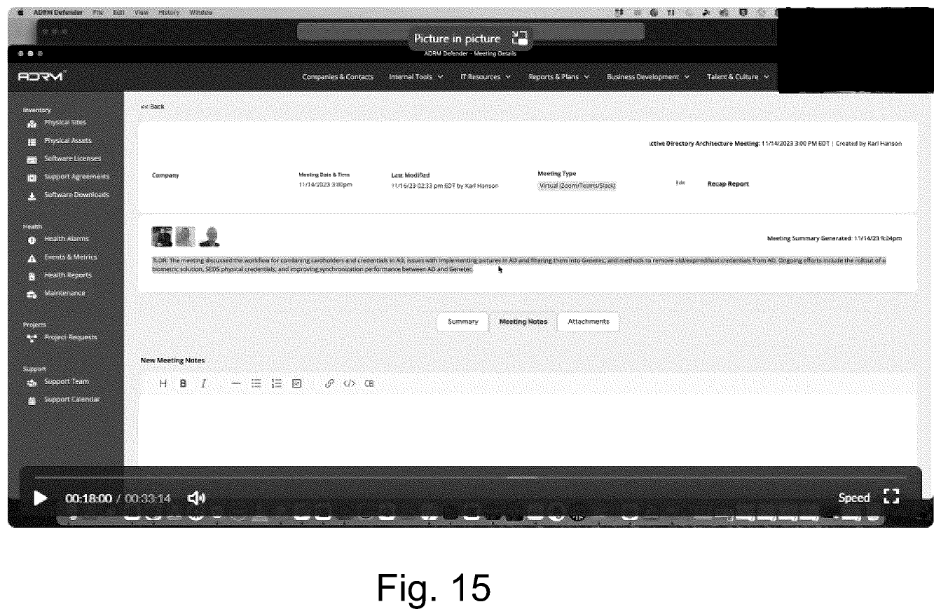

In certain embodiments, with reference now to FIGS. 15-18, the one or more AI/ML modules 512 are preferably configured to read user input data regarding the client managed assets and generate user readable reports relating to the user input data in combination with the data aggregated in the database. For example, in certain embodiments, the user input data includes client financial data (e.g., client budgets) and/or client management data (e.g., client news, client changes, client questions), and the user readable report includes one or more of: an executive summary of the client managed assets with respect to the client financial data, a budget proposal for upgrades to the client managed assets with respect to the client financial data, or a strategic planning proposal for improving the client managed assets with respect to the client financial data, the client management data, as well as the data discussed in the preceding paragraph.

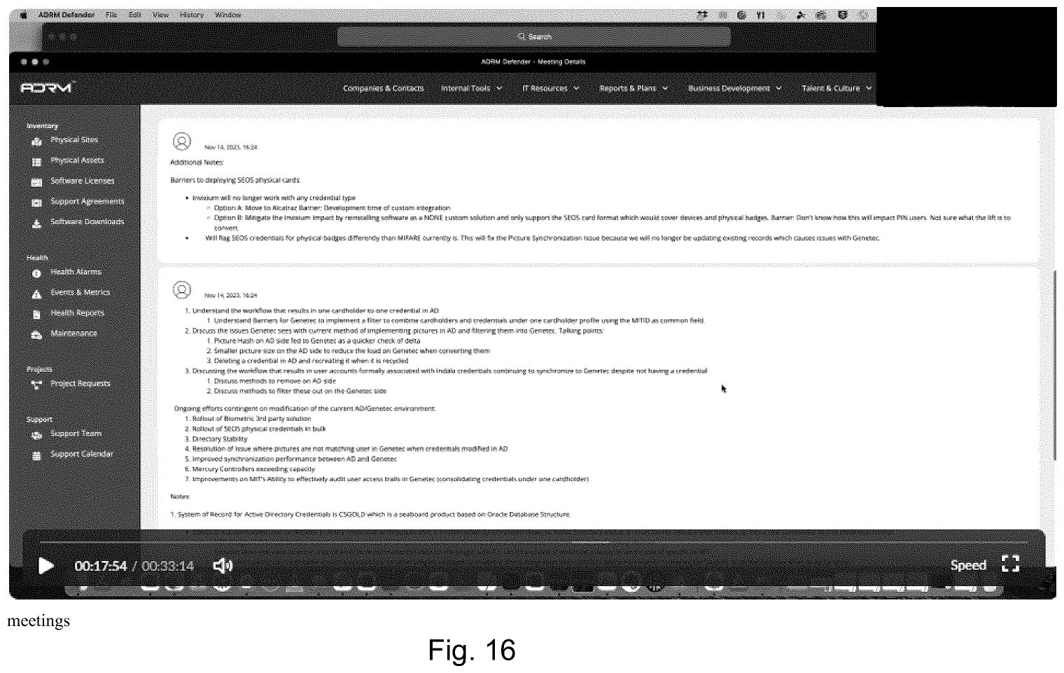

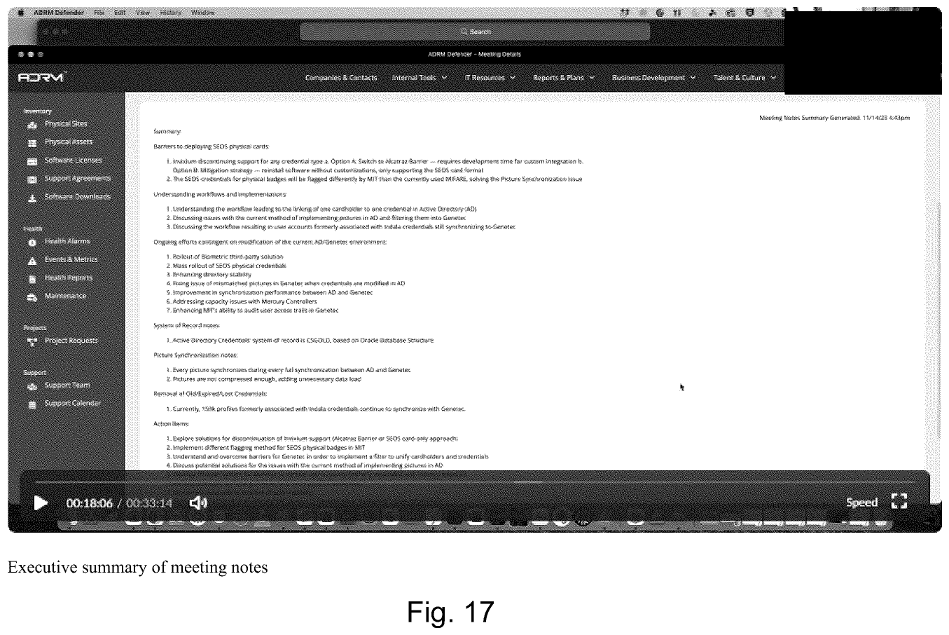

For example, as shown in FIG. 15, the user input data includes meeting notes taken by the system administrator or client during a management meeting. As an example, a meeting conducted with the client includes topics such as implementing new access panels, adding additional card readers to certain building entrances, upgrading one or more portion of the system, upgrading or replacing one or more assets, or the like. During the meeting, the GUI offers the client and/or system administrator to input meeting notes while the meeting is conducted, for example in a meeting notes tab as shown in FIG. 15. FIG. 16 shows a view of the meeting notes once they have been saved to a client profile. With reference to FIG. 17, once the meeting is concluded, the AI/ML modules 512 read the meeting notes taken during the meeting and automatically summarize and format the meeting notes into an executive summary, which are stored in the database and associated with the respective client. As shown, the summarized meeting notes include categorized discussion topics, with details relating thereto in bullet format. At the end of the executive summary, in certain embodiments preferably included is a list of action items that are extracted from the meeting notes. The executive summary provided by the AI/ML modules thus reformats notes into a format that is quick and easy to parse once the meeting is complete. Meeting notes for meetings conducted are then be saved to the database to be easily accessible to the client in a single location.

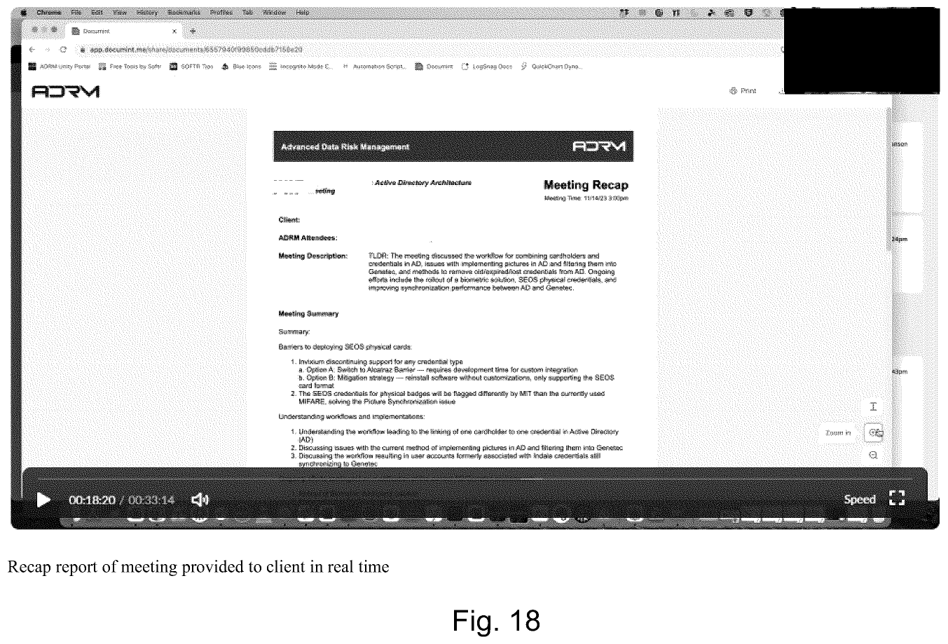

As shown in FIG. 18, the automatically generated executive summary in certain embodiments is preferably generated as a meeting summary client report which may be sent to the client and/or saved in the database available for a client to download later. It is noted the report can be different than the executive summary because it can include letter head, graphical images or logos, and more formal formatting than the text based executive summary. The meeting report in certain embodiments is generated as a separate document, outside of the GUI, while each of the meeting features shown in FIGS. 15-17 is within a single frame of the GUI. The meeting report shown in FIG. 18, is generated, and sent to the client in real time, so there is limited, if any, lag time between the close of the meeting and the client receiving the summary report.

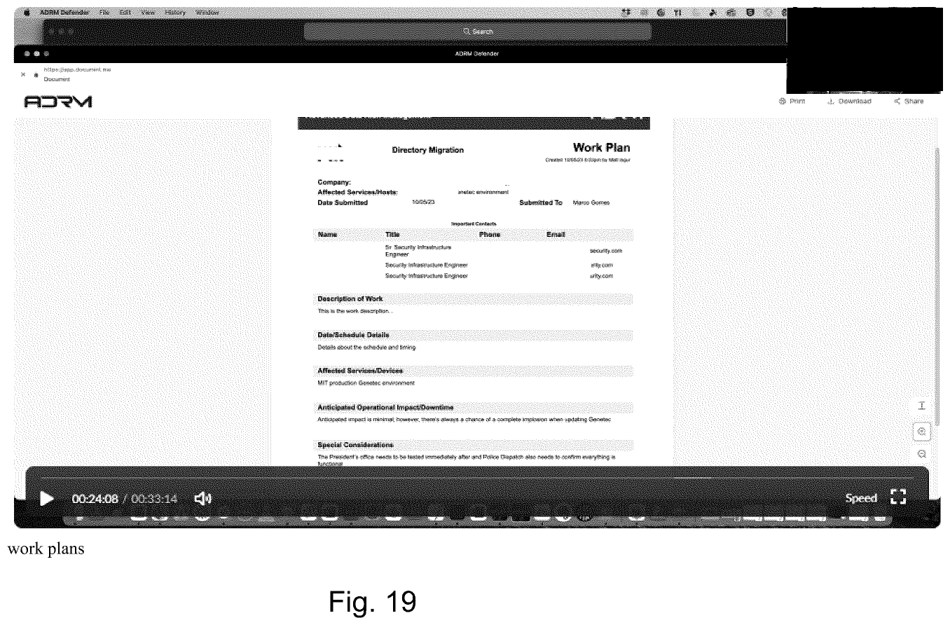

Now referring to FIG. 19, the user readable reports in certain embodiments preferably includes a work plan wherein the AI/ML modules are preferably configured to generate the workplan. In certain embodiments, the workplan is automatically generated based on a previous meeting, or in certain embodiments, the workplan is preferably generated by a system administrator based on client information provided by the client, in view of the aggregate data already stored in the database. In embodiments, such as shown, the workplan includes contact information for the work to be done, the description of the work, data and time information, what systems will be affected by the work, among others. The fields included in the workplan can be changed or modified based on client preference or based on client need.

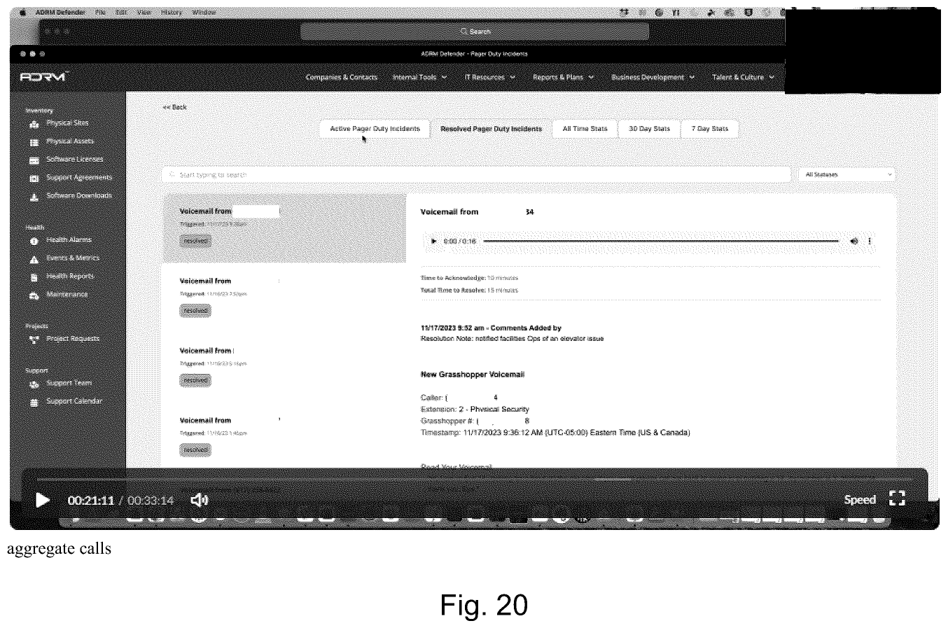

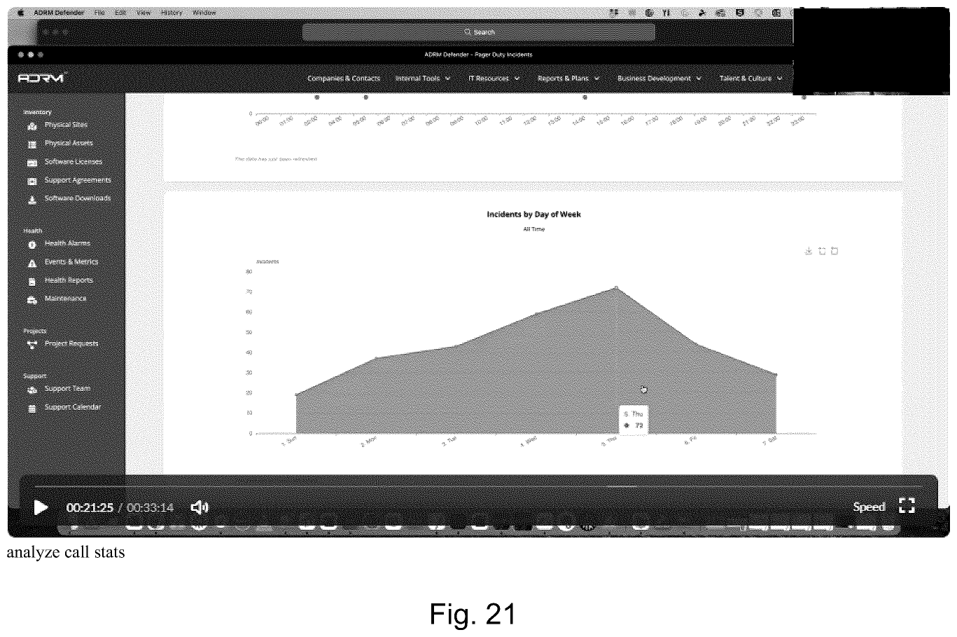

Turning now to FIGS. 20 and 21, in certain embodiments, the one or more AI/ML modules 512 are preferably configured to perform real time pattern recognition on the database, and the generated user readable reports to include, for instance, one or more of: client specific system performance reports, client specific asset performance reports, industry wide system performance reports, industry wide asset performance reports, installer (e.g., integrator) performance reports, and incident reports. Also, in embodiments, the one or more AI/ML modules 512 are configured to interpolate client communications (e.g., email, phone, pager, or other) to detect one or more conditions and/or events relating to one or more assets associated with a certain client. For example, as shown in FIG. 20, the system 502 detects and aggregates instances of client communications.

FIG. 20 specifically shows a portion of the GUI where phone calls and voicemails are aggregated into a searchable/filterable list where a system administrator or the AI/ML modules listens to the voicemails and view/review information relating thereto. The voicemails, in addition to other client communications are tagged as “incidents”, for example, and the AI/ML modules 512 performs pattern recognition and analysis on the incident data and generate reports regarding the incidents. For example, still in FIG. 20, the incidents are sorted into active incidents, resolved incidents, all time stats, 30 day stats, or 7 day stats. In certain embodiments, the AI/ML modules 512 generate reports such as shown in FIG. 21, which includes a graphical representation of a total number of incidents occurred (y-axis) for each day of the week (x-axis). In this example, it can be seen that more calls happen on Thursday than any other day per week, and there is a steady incline in incidents from Monday until Thursday. This information is useful for system administrators in a number of ways, for example for staffing/scheduling purposes. Other charts or graphs are generated based on user preference, for example, incidents per time of day.

In certain embodiments, the incident data discussed above are filtered based on integrator (the party that installed the client assets). The AI/ML modules then preferably analyze the incident data in addition any one or more of the other reports discussed above, to generate client recommendations regarding systems, assets, and/or integrators, in response to client request. For example, if a client requests information regarding their system, or requests information from system administrator regarding what systems are recommended, or what integrators are recommended, the AI/ML modules are configured to generate a report based on the aggregate data showing which systems perform best and which integrators perform best in view of any given client parameters (e.g., type of system to be installed, type of structure on which the system will be installed, geographic location of the client and its relative climate, among others). In certain embodiments, the AI/ML modules are configured to grade the assets, system packages, and integrators and generate grade reports based on measured performance as observed in the aggregate data. The grade reports are then preferably sent to clients or used internally for making client recommendations, similar to a customer review system or a “consumer report” system.

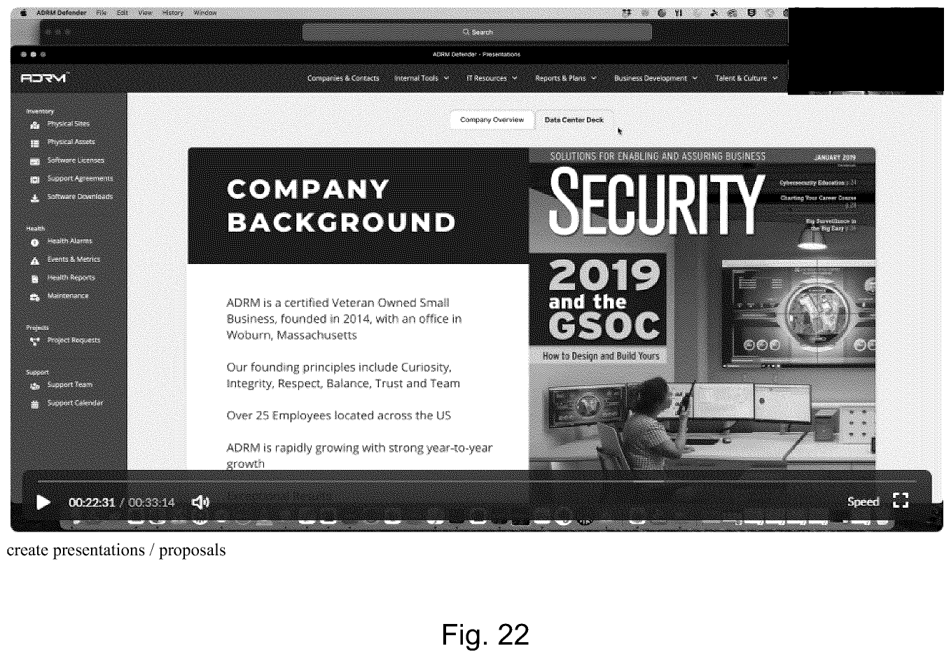

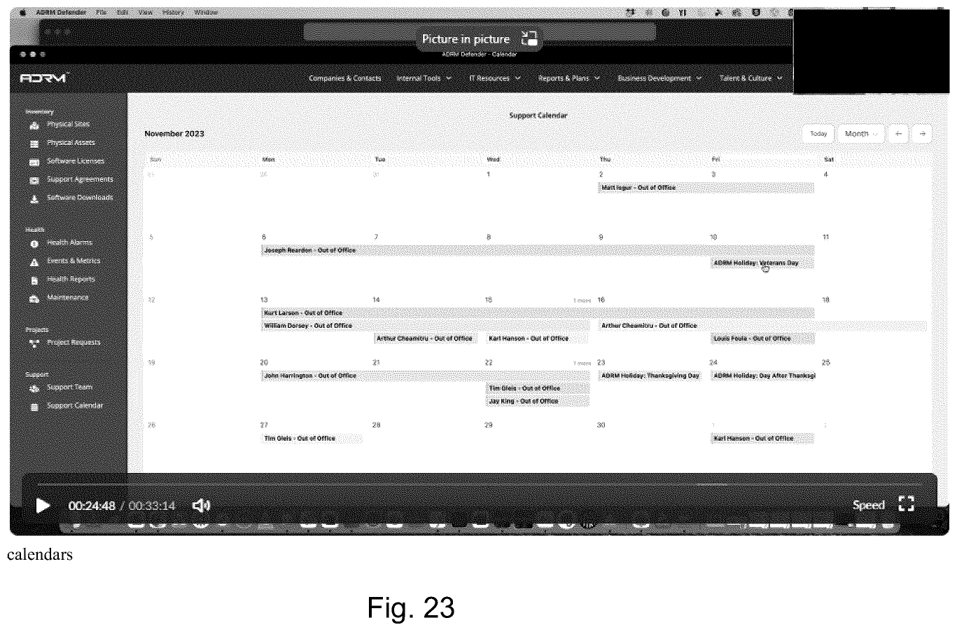

Turning now to FIGS. 22 and 23, the system 502 in certain embodiments is preferably accessed and utilized by a system administrator for internal company management and business development. For instance, the data aggregated in the database is useful for generating new business proposals for current clients or engaging new clients. For example, as shown in FIG. 22, the AI/ML modules 512 are configured to generate a proposal presentation based on cost data for existing assets and trends observed within the aggregate data in the database, and further configured to extrapolate a project's future cost based on user provided data, including potential system upgrades or first-time installations. The system 502 may also generate the presentations and budget proposal documents significantly faster than traditional methods, where data is not aggregated into a single database, for example. In FIG. 23, shown is an example of an internal system administrator management calender, which is useful for scheduling staff, and for scheduling client specific tasks, for example system maintenance for clients. FIGS. 22 and 23 are only representative of examples of the business development and internal management capabilities, and are in no way limiting.

Referring again to FIG. 5, in accordance with at least one aspect of this disclosure, a security asset computer implemented management system 500 (and associated method) preferably includes an information intake module 502 operatively connected to a plurality of client systems 504 each having a plurality of managed physical security assets 508. The intake module 502 is configured to receive information/data associated with physical security assets 508. The system includes an aggregation module 506 operatively connected to the information intake module configured to aggregate and store the received information into a database 510. The system further preferably includes one or more analytical modules 512 operatively connected to the aggregation module 506 configured to parse the information within the database 510 to compartmentalize the information/data into one or more categories of information. The method performed by the system described herein in accordance with certain embodiments includes performing analytics on the stored data using machine instructions to manage the physical security assets associated with the plurality of client systems and/or generating one or more user readable reports regarding the managed physical security assets associated with the plurality of client systems.

In embodiments, the one or more analytical modules 512 include one or more artificial intelligence/machine learning (AI/ML) modules as discussed. In embodiments, the one or more analytical modules are operative and configured to perform pattern recognition on the compartmentalized data to determine trends within the data and make recommendations to a user based on the trends. Here, the user includes a system administrator, or the user includes a client whose systems are managed by the system administrator.

In embodiments, the one or more analytical modules are further operative and configured to perform anomaly detection on the compartmentalized data to determine health status of one or more physical security assets associated with a respective client. In certain embodiments, the one or more analytical modules are further operative and configured to determine maintenance recommendations to a user based on a determined health status of one or more physical security assets associated with a respective client. In certain embodiments, the physical security assets include one or more of a plurality of security cameras, security door locks, security key card access panels, security biometric panels, security alarms, seismic detection systems, and fire detection systems, among others.

In embodiments, the plurality of client managed physical security assets include one or more of a plurality of physical security assets from a plurality of clients, such that each respective client of the plurality of clients has a plurality of physical security assets. In certain such embodiments, the information intake module is operatively connected to each physical security asset of each respective client to receive information from each physical security asset of each respective client. In certain embodiments, the information intake module receives information directly from each physical security asset of each respective client, via one or more electronic wireless means (e.g., e-mail). For example, the information intake module receives email directly from a security asset as events occur and/or on a scheduled basis set by the client.

In embodiments, the compartmentalized information includes client specific information, physical security asset specific information for a specific client, specific physical security asset information for all clients in aggregate. In certain such embodiments, the client specific information includes aggregate information for physical security assets for a respective client (e.g., all or some). In certain embodiments, the physical security asset specific information for a specific client includes information relating to a particular physical security asset for the specific client or physical security asset type for the specific client or a predefined group of physical security assets for the specific client.

In embodiments, the specific physical security asset information for all clients in aggregate includes information relating to a particular physical security asset across all clients or physical security asset type across all clients or a predefined group of physical security assets across all clients (e.g., exterior versus interior assets, or based on geography of the installed assets).

In certain embodiments, a particular physical security asset includes a single physical security asset, for example, a single camera, or single door lock. In certain embodiments, physical security asset type includes at least physical security assets of a particular model number (e.g., all cameras of a particular model or classification number) or a category of asset (e.g., all cameras generally). In certain embodiments, the predefined group of physical security assets includes, at least: a user defined group of physical security assets, defined by geographic location, location within a security ecosystem, and proximity to a particular structure, for example, exterior versus interior assets, or assets in a particular ecosystem such as an office building versus a parking structure, or assets in a particular geographic environment such as below or above a certain temperature, or assets in proximity to certain structures such as windows versus doors versus vents, for example.

In accordance with at least one aspect of this disclosure, such as shown in FIGS. 6-23, there is provided a graphical user interface (GUI) (e.g., GUI 600 as discussed above) for display on a display screen of a user device. The GUI is preferably configured for display in a window occupying all or a portion of the display screen relating to management of a plurality of assets associated with one or more clients. In embodiments, the GUI includes, a first frame occupying a first frame region of the window, and the first frame illustrates an overview of a plurality of assets associated with one or more clients.

Within the first frame, as shown in FIG. 7, the first frame preferably includes a plurality of user selectable options, which are categorized into, at least, a first 750, second 752, and third 754 plurality of user selectable options. The first plurality 750 are included on all frames within the GUI, while the third plurality 754, and any additional pluralities of user selectable options, are change based on the frame selected within the GUI. This can be seen as the figures progress through different portions of the GUI in FIGS. 6-23.

In FIG. 7, the first plurality of user selectable options 750 includes inventory options, asset health options, project options, and support options, which are shown in a left-hand side of the first frame. The inventory selectable options includes user selectable options wherein a system administrator views physical sites where systems are installed for all clients or selected clients, a listing of physical assets owned by all clients or selected clients, among other options. The health options include user selectable options including health alarms, events and metrics, health reports, and maintenance. These options allow a system administrator to view health related data for all or selected clients. In a client facing GUI, a client would be able to view and select any one of the options listed, but can only view data with respect to their own assets. The projects options includes project requests, which is received from clients and sorted with the AI/ML modules, and the support options include system administrator selectable options for internal management support.

The second plurality of user selectable options 752 as shown in an upper section of the first frame includes selectable options, company and contacts, internal tools, IT resources, reports and plans, business development, among others. The second plural of selectable options 752 may not be included in a client facing GUI, but only for system administrators. Each option in the second plurality 752 includes a drop down menu with further selectable options.

The third plurality of user selectable options 754 is preferably used to toggle between subframes within a frame. For example, the first frame that is shown in FIG. 7 is a listing of all clients held by the system administrator. In this case, each client is in itself a user selectable option. The third plurality of options 754 include company, and contacts, where company is currently selected. Selecting the contacts option would keep the GUI in the first frame, but would change the listing of clients to a listing of contacts.

FIG. 8 shows an example of when a client is selected from the frame in FIG. 7. Here it can be seen that the first and second pluralities of options 750 and 752 have remained the same, but the third plurality of user selectable options 754 has changed to be specific to the selected client. Further, a fourth plurality of user selectable options has now been populated, the fourth plurality of options including of one or more of: a listing of physical locations at which a client system is installed, a listing of physical system assets installed at one or more of the physical locations, a listing of management meetings and associated minutes, a listing of client proposals, and/or a listing of client generated reports and management generated reports. As shown in FIG. 8, in embodiments, the listing of physical locations at which a client system is installed further includes graphical images of the physical locations (e.g., photos taken by an installer).

In FIG. 9, a frame is shown in which the physical assets option in the first plurality of options 750 has been selected. Here, the third plurality of options 754 has once again changed to be specific to the inventory option selected and a fourth plurality of options has now been populated, where the fourth plurality includes the listing of physical assets include a graphical representation (e.g., a manufacturer stock image of the asset or a clip art image of the type of asset) of each respective physical asset within the listing and visual and textual information associated with the respective asset. In certain embodiments, the visual and textual information associated with the respective asset include, at least: color indictors for identifying a status of the asset (e.g., green for deployed, online and/or active, red for anomaly detected, offline, inactive, or other error, and yellow for attention required). The textual information identifies a name of the asset (e.g., camera 1, door lock west door, or the like), and includes textual information identifying a model number of the asset, and includes textual information associated with the colored status indicator. In embodiments, the graphical images, colors, and textual information is assigned based on user preferences. In embodiments, the assets shown in the GUI are the physical security assets described above. A similar scheme occurs for each option selected in the first plurality of selectable options 750, as can be seen in FIGS. 9-23, and is therefore not repeated herein for every frame.

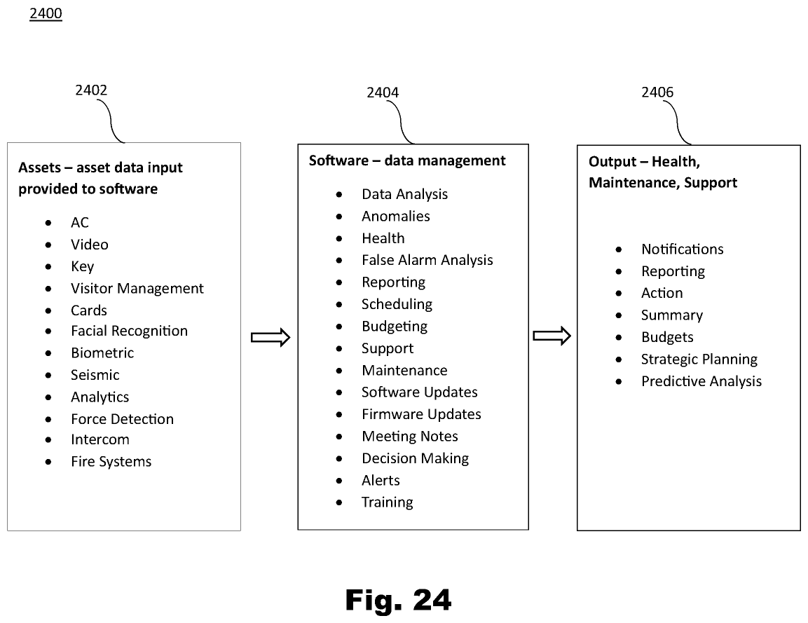

FIG. 24 shows a flow chart 2400 where the first step 2402 includes an exemplary list of types of client assets which provides data to the data management system. The data management system receives the information from the assets and provide any one or more, or all, of the exemplary items listed in the second step 2404. The items listed in step 2404 are provided by the one or more AI/ML modules, or facilitated by the AI/ML modules. As a result of the software, the data management system provides deliverables to the client who's asset data are managed by the data management systems. An exemplary list of deliverables that can be provided to the client are shown in step 2406. The lists shown in FIG. 24 are exemplary and not exhaustive.

In certain embodiments, the GUI is configured to display a number of windows, including any one or all of the following landings: a home landing page, a companies and contacts landing page, an internal tools landing page, an IT resources landing page, a business development landing page, a projects landing page, a reports and plans landing page, a talent and culture landing page, a beta features landing page, a unified monitoring center landing page, an inventory landing page, a health landing page, and a support landing page.

In certain embodiments, certain landing screens and their associated features may be available only to a system administrator, while certain landing screens and their associated features may also be available on a client facing version of the GUI. In certain embodiments, pages may be displayed to both system administrators and clients, but in different formats, for example, while a client facing version of the GUI may display all landing pages, the client facing interface may not allow for user interaction with all landing pages or may not display all subpages.

In certain embodiments, each landing page contains any number of subpages relating thereto. Each landing page and its associated subpages and functionality will be discussed in turn. While specific examples of landings and subpages are shown and described, one having ordinary skill in the art would readily appreciate in view of this disclosure that any suitable number of landings and subpages are added or removed and can be modified or renamed to better serve the user, without departing from the spirit of this disclosure.

In certain embodiments, the subpages associated with each respective landing page are displayed as tabs on the respective landing page so that a user toggles between subpages without leaving the selected landing page (e.g., as shown). In certain embodiments, the landing pages are displayed to the user on a side bar. The landing pages are organized by category as desired. In certain embodiments, the landing pages are displayed to the user on a top bar having drop down features. In certain embodiments, the side bar and top bar are static, e.g., the links to all landing pages will always be displayed to the user regardless of which landing page is currently selected.

In certain embodiments, the home landing page is a main page viewed by the user when the GUI is initialized. The home landing page can house, among other things, links to other landing pages, such as those described herein, as well as its own subpages. In certain embodiments, the subpages included on the home landing pages include, new features (FIG. 25), beta features (FIG. 25), a features road map (FIG. 26), and system statistics (FIG. 27).

In certain embodiments, the GUI includes a companies and contacts landing page which has at least following subpages: companies & contacts. The companies & contacts subpage provides a repository of all clients/companies enrolled in the monitoring system. Clicking on a specific company/client will direct the user to a new page that includes relevant information associated with that client, for example, addresses, websites, account manager, and the like. Each respective company/client page can also serve as a landing page having a number of toggle tabs so that a user can view more specific information relevant to the selected client, such as: physical sites, contacts, assets, support team, licenses, support agreements, integrators (e.g., local system installers), meetings (e.g., notes and minutes), proposals, reports, and support tickets.

In certain embodiments, the GUI includes an internal tools landing page which has at least the following subpages: system owner graphic identity (e.g., logos, colors, branding, etc.); system owner people directory (e.g., names, addresses, local offices, supervisors, titles, and contact information); policy library; AI tools (e.g., for generating text, images, code, emails, or the like); alert parser (including a real time list of all parsed alert events or triggers filterable by type), client onboarding, meetings (e.g., to standardize meeting outlines and minutes and automatically record relevant bibliographic information and minutes); and support tickets (e.g., to view and review open, resolved, and closed tickets and ticket metrics).

In certain embodiments, the GUI includes an information technology (IT) resources landing page which contains at least the following subpages: an internal IT asset catalog (e.g., cellphones, laptops, etc.); an internal IT assets status log (e.g., deployed, assigned to employee); an internal IT equipment request feature to request new equipment; and an internal IT support ticket system. The IT resources landing page can be restricted for system administrators view only and may not be client facing since the information and functionality provided on or by these subpages are relevant to internal users such as administrators and employees, rather than clients.

In certain embodiments, the GUI includes a business development landing page which contains at least the following subpages: presentations; proposals; and Request for Information (RFIs). The business development landing and subpages assists system administrators ensure information provided to prospective clients is accurate and up to date. The subpages allow administrators to generate new presentations or proposals manually or by pulling information from already generated work requests. This functionality allows a system administrator to enter certain limited information and the system will generate a fully formatted presentation or proposal for a specific client tailored to that client's needs. The business development page also allows for real time tracking of presentations and proposals, including the stage of the process the documents are in (e.g., rough draft, submitted for approval, approved, and sent to client, etc.). The RFI subpage allows a system administrator to communicate directly with a client or potential client from the RFI subpage to request information, e.g., information that may be used for specific client administration.

In certain embodiments, the GUI includes a project management landing page which contains at least the following subpages: project map; projects, projects by client; project states; project calendar view; and project Gantt view. The project management subpages allow for different visualization tools for tracking projects, e.g., geographical tracking or timeline tracking, as well as real time project status tracking. For example, the projects subpage includes a list of all projects and their status (active, upcoming, closed, hold/cancelled), along with relevant information about each project, including: client, project name, project lead, project status, project location, fees/costs, total invoiced, remaining value, project region, and overall progress, etc. A system administrator can choose to view any one of the Projects in the list. Doing so will generate a separate page which populates with specific details regarding the project including a breakdown of Project Phases and Project notes. Each project can also be graded, and the project rating can be referenced when looking for integrators in a particular region (e.g., to determine which installers perform best based on a geographic location of the system to be installed). In certain embodiments, the project statistics subpage visually illustrates project percent completion and describes phase of the project (assessment, design, project management, closeout), e.g., using various charts and graphs to track, among other things, projects by region, project by status, project phases by status, top 10 projects by total cost, projects by project lead, etc.

In certain embodiments, the GUI includes a reports and plans landing page which contains at least the following subpages: account services report; after action reports; incident reports; managed services reports; recommendation reports, and work plans. The database stores historical reports for each client and for each asset owned by the client. record. Reports can be generated using the reports landing page and drawing from the data stored in the database, the report can include any relevant information desired by the client, or a standardized report can be generated for every client and provided on an interval basis. Incident reports and after-action reports can also be generated using real time data regarding incidents, for example, the database stores data relating to system outages whether partial or full, how the outage or incident was discovered, what services or entities were affected, incident duration, and status, etc. Report generation in view of, or after an incident, allows for more effective documentation and storage of data to be used when making recommendations to clients in the future, or when revisiting internal policies for addressing the incidents when they occur. Recommendation reports can thus be generated in view thereof, e.g., to describe system improvements and recommendations to enhance stability and resilience.

In certain embodiments, the GUI includes a talent and culture landing page which includes at least the following subpages: conferences, employees, organization chart, holidays, subscriptions, and certificates. The views and functionality of the talent and culture landing page and subpages can assist in live tracking of internal happenings, such as hiring and onboarding, managing subscriptions and certifications, and allow for better internal transparency. The talent and culture landing page can be restricted for system administrators view only and may not be client facing since the information and functionality provided on or by these subpages are relevant to internal users such as administrators and employees, rather than clients.

In certain embodiments, the GUI includes a beta features landing page which contains at least the following subpages: beta features, new features, and system statistics. The beta and new features pages can include displays, illustrations, or demonstrations to showcase newly released features, or features coming soon.

In certain embodiments, the GUI includes a unified monitoring center landing page which includes at least the following subpages: unified monitoring center. In certain embodiments, the unified monitoring center provides real-time notifications of events and will stay active in this subpage until they are dismissed (or automatically cleared after a prescribed period). In certain embodiments, the active notifications describe the event, how many times the event occurred, how long it has been active, company that is impacted, timestamp, and special instructions (where applicable), and the like.

In certain embodiments, the GUI includes an inventory landing page having at least the following subpages: physical sites; in-stock assets; deployed assets; and software licenses, support agreements, software downloads. The inventory subpages allow a user, e.g., a system administrator, to view all clients and their respective installation locations in a number of different visual formats (e.g., map view, bar charts, photographs of the location, and the like). The in-stock assets subpage illustrate a catalog of assets available to a given client that have not yet been deployed. In certain embodiments, when a user selects an individual asset, specific details including the physical location, notes, and audit log are referenced and associated with that individual asset. In certain embodiments, the system initiates, and the GUI can display a Low Quantity Alert when the quantity of an asset drops below a pre-defined threshold. Also in the inventory subpage, the GUI is configured to allow a user to edit assets, check-in, or check-out assets, and/or print labels for the respective asset (e.g., barcodes, QR codes, or the like). The deployed asset subpage also include a number of different visual representations of information relating to the assets that are associated with and deployed for a certain client.

In certain embodiments, the GUI displays different visual representations for the following, or the following can be used as filters for the visual representations of the data, including Assets by Location, Assets by Company, Assets by Category (e.g., Access Control Device, Battery Powered Lock, Video Device), and Assets by Models (e.g., Axis, Hanwha, Mercury, etc.). In certain embodiments, subitems are used for tracking “children” items of “parent” deployed assets, for example tracking a deployed asset (emergency kit) and tracking it's subitems (contents of the kit) as well as any expiration dates and scheduled checks/audits. In certain embodiments, the deployed asset subpage provides the ability to view a camera view for each camera asset deployed by that client. In certain embodiments, the system automatically tracks product licenses, hardware/software/firmware versions, support agreements, expiration dates, of deployed assets. The system provides applicable files for download by the client from the subpage in order to ensure all parts are up to date. In certain embodiments, the system and GUI includes automated alerts tied to these Software Licenses and Support Agreements to ensure all assets remain up to date.

In certain embodiments, the GUI includes a health landing page which can house at least the following subpages and/or features: active notifications; monitored events; parsed events; custom events; health reports; and maintenance. In certain embodiments, an active notification alert (e.g., a pop up, banner, ticker) is displayed on any landing page when an incident occurs (e.g., an alarm is triggered) so that a user does not need to seek out the particular page to view an alert. In certain embodiments, the alert notifications are configured such that they only display on certain landing pages, such as the home landing page or the unified monitoring center landing page. Monitored events, parsed events, and custom events represented different filtered views of alert events that have occurred in the past and been recorded and stored in the database. Events can be filtered by any number of parameters, such as total events (last 30 days), unique events (last 30 days), and unique events (last 7 days); health metrics such as by hour of day, day of week, by client, top 15 devices, etc.; or recent or archived events, and the like. Selecting a particular event displays certain parsed information regarding the event, including data received from the asset by the system. In certain embodiments, system maintenance is scheduled, viewed, or edited in the maintenance subpage.

In certain embodiments, the GUI includes a support landing page which has at least the following subpages: support team; and support calendar. The support team provides a directory of system administrators, while the support calendar displays calendar items relating to out of office days, holidays, or days off for certain or all support staff.

As used herein the term “system administrator” refers to a provider of the data management system as described herein. The term “client” refers to a user of the data management system. For example, a “client” is a party that subscribes to the data management system as a service, provided by the “system administrator.”

In accordance with at least one aspect of this disclosure, there is provided a managed security systems software as shown and described.

In accordance with at least one aspect of this disclosure, there is provided a security data aggregator and user interface for presenting aggregated data as shown and described.

In accordance with at least one aspect of this disclosure, there is provided a non-transitory computer readable medium configured to cause a computer to perform a method as shown and described.

Embodiments include a novel Managed Security Systems Software (MSSS) that not only monitors various technological security data/devices but also provides tools to proactively manage security, greatly reduce human error, and present data from everything related to a building's security in an easily understandable format.

Embodiments of the MSSS are configured and operative provide a centralized solution for facility security management. Embodiments can efficiently monitor a wide range of security data and devices, including access control, video surveillance, key access control, visitor management, card access control, biometric data, seismic data, analytics, fence detection, intercoms, device health, license status, contract status, among others.

Embodiments of the MSSS include the following functionalities: data collection and integration, preventative maintenance, anomaly detection, software and firmware updates, reporting and analysis, budgeting and contract management, employee training and support, and meeting notes and alerts. Each of these functionalities can all be included in the single system and easily accessible in a single GUI.

For data collection and integration, embodiments of the MSSS integrate with various security devices and systems to collect real-time data for a plurality of clients and unifies data from disparate sources and formats for streamlined analysis. Each respective client can access their own data, but not other clients, while system administrators access all client data to generate reports for clients, and to view and analyze industry wide trends.

Regarding preventative maintenance, embodiments actively monitor overall system health for each client, identify issues in real-time, and proactively schedule maintenance tasks to prevent downtime and security vulnerabilities.

With respect to anomaly detection, utilizing advanced analytics, embodiments identify and highlight anomalies in the security data, which may indicate potential security breaches, system failures, or other critical issues. The anomaly detection can be performed for each client individually, or across all clients, which can reveal anomalies for certain assets (e.g., certain model numbers are defective or performing worse than others).

For software and firmware updates, embodiments ensure that all security devices are up-to-date with the latest software and firmware, reducing vulnerabilities.

With respect to Reporting and Analysis, certain embodiments compile data into easy-to-understand key performance indicators (KPIs), notifications, reports, and summary formats, enabling informed decision-making and strategic planning. The reporting and analysis is based on client specific data alone, and/or includes reports that take into account client specific data and industry wide trends, for example.

Regarding, budgeting and contract management, certain embodiments assist in budgeting, contract management, and resource allocation based on the analysis of security data and trends.

Relating to employee training and support, certain embodiments offer support for employee training, maintains records, and facilitates job scheduling.

For meeting notes and alerts, certain embodiments allow users to document and track security-related meetings, and provides customizable alerts for critical events.

Certain embodiments of the systems and methods described herein provide the following advantages over current data management systems: providing proactive security management, reducing response time to potential threats; providing clear, easily understandable reports and notifications for informed decision-making; facilitating budgeting and contract management based on data analysis; reducing the likelihood of human errors in security monitoring; supporting employee training and maintenance scheduling; and ensuring security devices are kept up-to-date with software and firmware updates.

Embodiments of the MSSS as shown and described herein include an innovative solution to data management that not only streamlines the management of complex security systems but also enables proactive and efficient security measures. Embodiments can be used across various industries to enhance facility security and protect against potential threats.

As will be appreciated by those skilled in the art, aspects of the present disclosure may be embodied as a system, method or computer program product. Accordingly, aspects of this disclosure may take the form of an entirely hardware embodiment, an entirely software embodiment (including firmware, resident software, micro-code, etc.), or an embodiment combining software and hardware aspects, all possibilities of which can be referred to herein as a “circuit,” “module,” or “system.” A “circuit,” “module,” or “system” can include one or more portions of one or more separate physical hardware and/or software components that can together perform the disclosed function of the “circuit,” “module,” or “system”, or a “circuit,” “module,” or “system” can be a single self-contained unit (e.g., of hardware and/or software). Furthermore, aspects of this disclosure may take the form of a computer program product embodied in one or more computer readable medium(s) having computer readable program code embodied thereon.

Any suitable combination(s) of any disclosed embodiments and/or any suitable portion(s) thereof are contemplated herein as appreciated by those having ordinary skill in the art in view of this disclosure.

With certain illustrated embodiments described above, it is to be appreciated that various non-limiting embodiments described herein may be used separately, combined or selectively combined for specific applications. Further, some of the various features of the above non-limiting embodiments may be used without the corresponding use of other described features. The foregoing description should therefore be considered as merely illustrative of the principles, teachings and exemplary embodiments of this invention, and not in limitation thereof.

It is to be understood that the above-described arrangements are only illustrative of the application of the principles of the illustrated embodiments. Numerous modifications and alternative arrangements may be devised by those skilled in the art without departing from the scope of the illustrated embodiments, and the appended claims are intended to cover such modifications and arrangements.

What is claimed is:

1. A computer-implemented method for a monitoring device for determining one or more analytics for aggregated assets, comprising:
capturing via a communications network, data from a plurality of assets associated with at least one entity, wherein the captured data have a plurality of different data file formats;
storing the captured data in a storage device;
normalizing the captured data stored in the storage device to have one or more standardized data formats;
analyzing the normalized captured data using one or more Artificial Intelligence (AI) techniques to aggregate the captured asset data into one or more asset data sets wherein each aggregated asset data set is associated with a common asset functionality; and
analyzing, each aggregated asset data set to determine one or more functionality trends associated with assets in each aggregated asset data set based at least in part on previously collected historical data and anomalies associated with a respective asset in each aggregated asset data set.

2. The method of claim 1, further comprising, applying one or more AI techniques to the normalized captured asset data for classifying the normalized captured asset data so as to be aggregated into the one or more assets data sets

3. The method of claim 2, wherein the one or more AI techniques apply one or more AI models to the one or more asset data sets for determining the one or more functionality trends associated with assets in each aggregated asset data set and/or for determining the historical data and anomalies associated with the respective asset.

4. The method of claim 1, wherein the functionality trends includes performance metrics according to prescribed criteria.

5. The method of claim 1, wherein the communication network includes use a LoRaWAN network.

6. The method of claim 1, wherein the data format files include binary or text-based files.

7. The method of claim 1, wherein the plurality of assets includes one or more of security devices, security cameras, security door locks, security key card access panels, security biometric panels, security alarms, seismic detection systems, fire detection systems, fire control devices, key or key card control devices, video access devices, building access panel devices, and/or environment control systems.

8. The method of claim 7, wherein the captured data includes operational data associated with a respective asset.

9. The method of claim 8, wherein the captured operational data is captured in real-time.

10. A non-transitory computer readable medium having computer executable instructions configured to cause a computer to perform a method for determining one or more analytics for aggregated assets, the method comprising:
capturing, via a communications network, data from a plurality of assets associated with at least one entity, wherein the captured data have a plurality of different data file formats;
storing the captured data, in a storage device;
normalizing the captured data stored in the storage device, to have one or more standardized data formats;
analyzing, the normalized captured data using one or more Artificial Intelligence (AI) techniques to aggregate the captured asset data into one or more assets data sets wherein each aggregated asset data set is associated with a common asset functionality; and
analyzing, by the computer processor, using one or more AI techniques, each aggregated asset data set to determine one or more functionality trends associated with assets in each aggregated asset data set based at least in part on previously collected historical data and anomalies associated with a respective asset in each aggregated asset data set.

11. The medium of claim 10, further comprising, applying one or more AI techniques to the normalized captured asset data for classifying the normalized captured asset data so as to be aggregated into the one or more assets data sets

12. The medium of claim 11, wherein the one or more AI techniques apply one or more AI models to the one or more asset data sets for determining the one or more functionality trends associated with assets in each aggregated asset data set and/or for determining the historical data and anomalies associated with the respective asset.

13. The medium of claim 10, wherein the functionality trends includes performance metrics according to prescribed criteria.

14. The medium of claim 10, wherein the communication network includes use a LoRaWAN network.

15. The medium of claim 10, wherein the data format files includes a binary or text-based files.

16. The medium of claim 10, wherein the plurality of assets includes one or more of security devices, security cameras, security door locks, security key card access panels, security biometric panels, security alarms, seismic detection systems, fire detection systems, fire control devices, key or key card control devices, video access devices, building access panel devices, and/or environment control systems

17. The medium of claim 16, wherein the captured data includes operational data associated with a respective asset.

18. The medium of claim 17, wherein the captured operational data is captured in real-time.

19. A monitoring system, comprising:
at least one monitoring device for determining one or more analytics for aggregated assets, having a data receiving module and a data analytics module,
wherein the data receiving module is configured to:
capture via a communications network data from a plurality of assets associated with at least one entity, wherein the captured data have a plurality of different data file formats;
store the captured data in a storage device; and
normalize the captured data stored in the storage device to have one or more standardized data formats;
wherein the data analytics module is configured to:
analyze the normalized captured data using one or more Artificial Intelligence (AI) techniques to aggregate the captured asset data into one or more assets data sets wherein each aggregated asset data set is associated with a common asset functionality; and
analyze each aggregated asset data set using one or more AI techniques to determine one or more functionality trends associated with assets in each aggregated asset data set based at least in part on previously collected historical data and anomalies associated with a respective asset in each aggregated asset data set.

20. The monitoring system of claim 19, wherein the plurality of assets includes one or more of security devices, security cameras, security door locks, security key card access panels, security biometric panels, security alarms, seismic detection systems, fire detection systems, fire control devices, key or key card control devices, video access devices, building access panel devices, and/or environment control systems.

21. A record management system for managing a security system having a plurality of assets, comprising:
a plurality of management modules operated on a single engine, the plurality of management modules, comprising:
an asset monitoring module configured to:
continuously capture in real time, via a communications network, data from a plurality of assets associated with an entity;
store the captured data in a storage device; and
normalize the captured data stored in the storage device to have one or more standardized data formats;
analyze the normalized captured data to aggregate the captured asset data into one or more assets data sets, wherein each aggregated asset data set is associated with a common asset functionality; and
analyze each aggregated asset data set to determine one or more functionality trends associated with assets in each aggregated asset data set based at least in part on previously captured and stored historical data and recorded anomalies associated with a respective asset; and
at least one or more of:
an asset management module configured to track deployed and stored asset inventory, wherein at least a portion of input data to the asset management module is derived from the aggregated data sets stored in the asset monitoring module;
a project management module configured to track and manage progress of installation of the assets at entity sites, wherein at least a portion of input data to the project management module is derived from the aggregated data sets stored in the asset monitoring module; and/or
an operations management module configured to track and respond to incidents noted by the entity, wherein at least a portion of input data to the asset management module is derived from the aggregated data sets stored in the asset monitoring module and wherein at least a portion of input data to the operations management module is derived from communications received from the entity.

22. The record management system of claim 21, wherein the asset monitoring module is configured to continuously capture in real time, via a communications network, data from a plurality of assets associated with a plurality of entities and wherein the previously captured and stored historical data and recorded anomalies associated with a respective asset is specific to a respective entity.

23. The record management system of claim 21, wherein the asset monitoring module is configured to continuously capture in real time, via a communications network, data from a plurality of assets associated with a plurality of entities and wherein the previously captured and stored historical data and recorded anomalies associated with a respective asset is aggregated for all entities.
